(19) United States
(12) Patent Application Publication
(10) Pub. No.: US 2026/0233958 A1
(43) Pub. Date: Aug. 13, 2026

(54) MEDIUM PROCESSING APPARATUS AND IMAGE FORMING SYSTEM

(71) Applicants: Yuusuke SHIBASAKI, Tokyo (JP); Atsushi SHINODA, Kanagawa (JP); Sho ASANO, Kanagawa (JP); Wataru TAKAHASHI, Tokyo (JP); Tomomichi HOSHINO, Kanagawa (JP); Shota YOSHIDA, Kanagawa (JP); Kotomi KAMEYAMA, Kanagawa (JP); Shuuto TOHKAISHI, Kanagawa (JP); Hirotaka YASUKAWA, Kanagawa (JP); Shingo YOSHIZAWA, Kanagawa (JP); Naofumi YOSHIDA, Kanagawa (JP); Ryota TAKAYAMA, Kanagawa (JP); Akira KUNIEDA, Tokyo (JP); Jun YAMADA, Kanagawa (JP); Yuji SUZUKI, Kanagawa (JP); Wataru NOZAKI, Kanagawa (JP); Satoshi HIRATA, Saitama (JP); Takuya OKAMOTO, Tokyo (JP)

(72) Inventors: Yuusuke SHIBASAKI, Tokyo (JP); Atsushi SHINODA, Kanagawa (JP); Sho ASANO, Kanagawa (JP); Wataru TAKAHASHI, Tokyo (JP); Tomomichi HOSHINO, Kanagawa (JP); Shota YOSHIDA, Kanagawa (JP); Kotomi KAMEYAMA, Kanagawa (JP); Shuuto TOHKAISHI, Kanagawa (JP); Hirotaka YASUKAWA, Kanagawa (JP); Shingo YOSHIZAWA, Kanagawa (JP); Naofumi YOSHIDA, Kanagawa (JP); Ryota TAKAYAMA, Kanagawa (JP); Akira KUNIEDA, Tokyo (JP); Jun YAMADA, Kanagawa (JP); Yuji SUZUKI, Kanagawa (JP); Wataru NOZAKI, Kanagawa (JP); Satoshi HIRATA, Saitama (JP); Takuya OKAMOTO, Tokyo (JP)

(73) Assignee: ETRIA CO., LTD., Yokohama (JP)

(21) Appl. No.: 19/536,966

(22) Filed: Feb. 11, 2026

(30) Foreign Application Priority Data
Feb. 13, 2025 (JP) 2025-021799

(51) Int. Cl. B65H 31/02; G03G 15/00

(52) U.S. Cl. CPC B65H 31/02; G03G 15/502; G03G 15/6541; B65H 2220/02; B65H 2301/4213

(57) ABSTRACT

A medium processing apparatus includes a housing having an opening through which a medium bundle including media is inserted in an insertion direction, a crimp binding device to crimp the medium bundle inserted through the opening on one side in a main scanning direction orthogonal to the insertion direction, an input device to receive an input on a medium size of the media and a binding position of the medium bundle to be crimp-bound by the crimp binding device, processing circuitry to determine an insertion orientation of the medium bundle to be inserted into the opening, an image orientation of an image on at least one of the media, and a front-rear orientation of the medium bundle, based on the medium size and the binding position received by the input device, and a notifying device to provide notification of the insertion orientation, the image orientation, and the front-rear orientation.

### CROSS-REFERENCE TO RELATED APPLICATION

This patent application is based on and claims priority pursuant to 35 U.S.C. § 119(a) to Japanese Patent Application No. 2025-021799, filed on Feb. 13, 2025, in the Japan Patent Office, the entire disclosure of which is hereby incorporated by reference herein.

### BACKGROUND

### Technical Field

The present disclosure relates to a medium processing apparatus and an image forming system.

### Background Art

Medium processing apparatuses have been proposed that can perform so-called manual binding to bind a medium bundle inserted through an opening. For example, for devices where a staple N penetrates a medium bundle to bind the medium bundle, the position at which a medium bundle is to be placed when the medium bundle is inserted with its front side facing downward such that the edges of a needle are positioned at the rear side of the medium bundle is indicated.

### SUMMARY

The present disclosure described herein provides a medium processing apparatus and an image forming system. The medium processing apparatus includes a housing having an opening through which a medium bundle including a plurality of media is inserted in an insertion direction, a crimp binding device to crimp the medium bundle inserted through the opening on one side in a main scanning direction orthogonal to the insertion direction, an input device to receive an input on a medium size of the plurality of media and a binding position of the medium bundle to be crimp-bound by the crimp binding device, processing circuitry to determine an insertion orientation of the medium bundle to be inserted into the opening, an image orientation of an image on at least one of the plurality of media, and a front-rear orientation of the medium bundle, based on the medium size and the binding position received by the input device, and a notifying device to provide notification of the insertion orientation, the image orientation, and the front-rear orientation determined by the processing circuitry. The image forming system includes an image forming apparatus to form an image on at least one of a plurality of media, a medium processing apparatus including a crimp binding device to perform crimp binding on a medium bundle including the plurality of media conveyed from the image forming apparatus in a conveyance direction and another medium bundle manually fed in an insertion direction, on one side in a main scanning direction orthogonal to the insertion direction and the conveyance direction, an input device to receive an input on a medium size of the plurality of media and a binding position of the medium bundle or the another medium bundle to be crimp-bound by the crimp binding device, processing circuitry to determine an insertion orientation of the another medium bundle manually fed, an image orientation of an image on the another medium bundle manually fed, and a front-rear orientation of the another medium bundle manually fed, based on the medium size and the binding position received by the input device, and a notifying device to provide notification of the insertion orientation, the image orientation, and the front-rear orientation determined by the processing circuitry. Alternatively, the image forming system includes an image forming apparatus to form an image on at least one of a plurality of media, a medium processing apparatus including a crimp binding device to perform crimp binding on a medium bundle including the plurality of media conveyed from the image forming apparatus in a conveyance direction and another medium bundle manually fed in an insertion direction and placed on a container, on one side in a main scanning direction orthogonal to the insertion direction and the conveyance direction, an input device to receive an input on a medium size of the another medium bundle manually fed and a binding position of the another medium bundle that is manually fed and is to be crimp-bound by the crimp binding device, processing circuitry to determine an insertion orientation of the another medium bundle manually fed, an image orientation of an image on the another medium bundle manually fed, and a front-rear orientation of the another medium bundle manually fed, based on the medium size and the binding position received by the input device, and a notifying device to provide notification of the insertion orientation, the image orientation, and the front-rear orientation determined by the processing circuitry. When the plurality of media on which the image has been formed by the image forming apparatus is placed in the container, the processing circuitry provides notification through the notifying device that the another medium bundle manually fed is not to be inserted. When the plurality of media on which the image has been formed by the image forming apparatus is fed to a place other than the container, the processing circuitry continues an operation of the image forming apparatus and provides notification of the insertion orientation, the image orientation, and the front-rear orientation through the notifying device.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is a diagram illustrating an internal structure of an image forming apparatus.

FIG. 2A is a side view of a binding apparatus, illustrating the internal structure thereof.

FIG. 2B is a plan view of a binding apparatus, illustrating a conveyance path therein.

FIG. 3 is a plan view of a binding apparatus, illustrating the location of an internal tray therein.

FIG. 4A and FIG. 4B are diagrams illustrating a configuration of a crimp binding device.

FIG. 5A, FIG. 5B, and FIG. 5C are diagrams illustrating a configuration of a stapler.

FIG. 6A and FIG. 6B are diagrams illustrating how a sheet bundle is manually fed through an opening.

FIG. 7A and FIG. 7B are diagrams illustrating a binding apparatus and how a sheet passes through or reaches a conveyance roller pair.

FIG. 8A and FIG. 8B are diagrams illustrating how a binding apparatus performs binding.

FIG. 9 is a diagram illustrating the binding apparatus of FIG. 8B as viewed in the thickness direction of a sheet.

FIG. 10A and FIG. 10B are diagrams illustrating a binding apparatus that ejects a sheet bundle having been subjected to a binding operation to a second output tray.

FIG. 11 is a block diagram illustrating a hardware configuration of an image forming system.

FIG. 12 is another block diagram illustrating a hardware configuration of an image forming system.

FIG. 13A and FIG. 13B are diagrams illustrating how a sheet bundle is manually fed with long-edge feed (LEF).

FIG. 14A and FIG. 14B are diagrams illustrating how a sheet bundle is manually fed with short-edge feed (SEF).

FIG. 15A to FIG. 15L are diagrams illustrating a combination of manual-feeding orientations of the sheet bundle and variations of binding positions by crimp binding on a sheet bundle.

FIG. 16A to FIG. 16L are other diagrams illustrating a combination of manual-feeding orientations of the sheet bundle and variations of binding positions by crimp binding on a sheet bundle.

FIG. 17 is a table indicating combinations of the setting data input by a user, manual-feeding orientations, and the position of a crimp binding device in the main scanning direction.

FIG. 18A to FIG. 18L are diagrams illustrating a combination of variations of binding positions by stapling on a sheet bundle and manual-feeding orientations of the sheet bundle

FIG. 19A to FIG. 19L are other diagrams illustrating a combination of manual-feeding orientations of a sheet bundle and variations of binding positions by stapling on the sheet bundle.

FIG. 20 is a table indicating combinations of the setting data input by a user, manual-feeding orientations, and the position of a stapler in the main scanning direction.

FIG. 21 is a flowchart of preparation processes for manual binding.

FIG. 22A is a diagram illustrating a job selection screen.

FIG. 22B is a diagram illustrating a binding quantity selection screen.

FIG. 23A is a diagram illustrating a binding method selection screen.

FIG. 23B is a diagram illustrating a sheet size selection screen.

FIG. 24A and FIG. 24B are diagrams each of which illustrates a binding position selection screen.

FIG. 25A is a diagram illustrating a manual-feeding orientation notification screen.

FIG. 25B is a diagram illustrating a stapling confirmation screen.

FIG. 26 is another flowchart of preparation processes for manual binding.

FIG. 27 is a flowchart of processes of manual binding.

FIG. 28A is a diagram illustrating a sheet bundle that is erroneously placed.

FIG. 28B is a diagram illustrating the relation between torque and number of revolutions per minute (rpm) of a fence motor.

FIG. 29A is a diagram illustrating an ejection notification screen.

FIG. 29B is a diagram illustrating a placement error notification screen.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more central processing units (CPUs), digital signal processors (DSPs), application-specific integrated circuits (ASICs), field-programmable gate arrays (FPGAs), computers, or the like. These terms may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

An image forming apparatus 1 is described below with reference to the drawings.

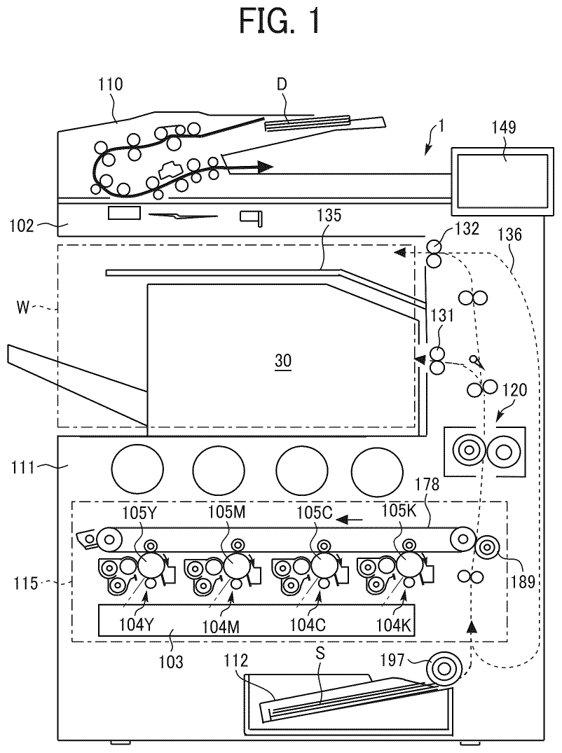

FIG. 1 is a diagram illustrating an internal structure of the image forming apparatus 1.

The image forming apparatus 1 forms an image on a sheet S that is an example of a sheet medium, typically, a sheet of paper. As illustrated in FIG. 1, typically, the image forming apparatus 1 is provided with a housing 111 and an image forming device 115.

The housing 111 has a box-shaped member having an inner space to accommodate components of the image forming apparatus 1. The housing 111 has an in-body space W that is accessible from the outside of the image forming apparatus 1. For example, the in-body space W is located slightly above the center of the housing 111 in the vertical direction. The in-body space W is exposed to the outside through a cutting that is made by cutting out a side wall of the housing 111. In the in-body space W, processing devices (e.g., an optional device and a binding apparatus 30) that perform various kinds of processes on a sheet S on which an image has been formed by the image forming device 115 are installed. The in-body space W is a space to which the sheet S can be ejected from the image forming apparatus 1, and is a space from which the sheet S ejected from the image forming apparatus 1 can be taken out.

For example, as illustrated in FIG. 1, a binding apparatus 30 that is an example of a medium processing apparatus is located in the in-body space W of the image forming apparatus 1. In this configuration, multiple sheets S on which images have been formed by the image forming device 115 are bound by the binding apparatus 30 and ejected to a second output tray 32.

Alternatively, the optional device and the binding apparatus 30 may be located in the in-body space W of the image forming apparatus 1. In such a configuration, a plurality of sheets S on which images are formed by the image forming device 115 are subjected to processing (e.g., liquid application to a binding position, punching of punch holes, or folding) by the optional device, subjected to binding by the binding apparatus 30, and ejected to the second output tray 32. The image forming apparatus 1 and the binding apparatus 30 (or the optional device) are combined to form an image forming system.

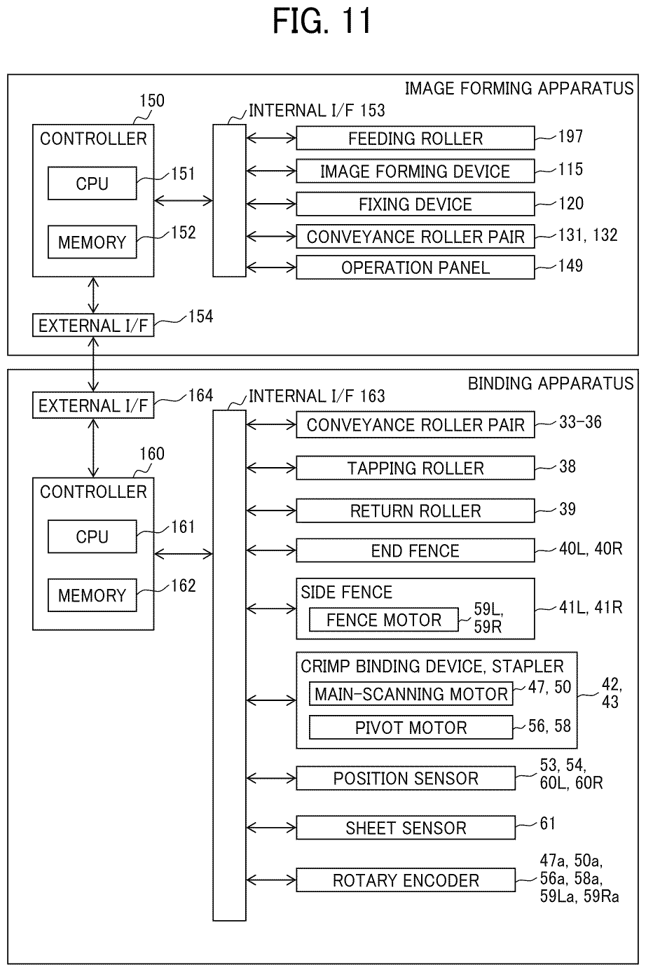

Each of the optional device and the binding apparatus 30 is manufactured as a unit and is connectable to an input-output (I/O) interface for a sheet S. In other words, the optional device and the binding apparatus 30 are replaceable depending on the intended use of the image forming apparatus 1. More specifically, the output interface of the image forming device 115 is connectable to the input interfaces of the optional device and the binding apparatus 30. Moreover, the input interface of the binding apparatus 30 is connectable to the output interface of the optional device. The adjacent units are connected to each other by, e.g., a mechanical lock or a magnet in a detachable manner. Each of the devices installed in the in-body space W is connected to a controller 150 (see FIG. 11) by a harness for transmitting and receiving various kinds of signals.

Alternatively, the image forming apparatus 1 may configure an image forming system in combination with a post-processing apparatus provided outside the in-body space W. Such a post-processing apparatus may be, for example, a device to implement a sorting function to sort a sheet bundle Sb, which is an example of a medium bundle, ejected from the binding apparatus 30. Inside the in-body space W of the image forming apparatus 1, a relay device may be installed that relays the sheet S on which an image has been formed, which is ejected to the in-body space W, to the post-processing apparatus. Such a relay device may be formed as a single integrated unit with the post-processing apparatus, or may separately be provided and attached to the post-processing apparatus. The post-processing apparatus may be, for example, the binding apparatus 30.

Typically, the image forming apparatus 1 is provided with a document conveying device 110, a document reading device 102, a feed tray 112, a feeding roller 197, an image forming device 115, a fixing device 120, conveyance roller pairs 131 and 132, and a first output tray 135. In the present description, the image forming device 115 of an electrophotographic system that forms an image using toner is described. However, no limitation is intended thereby, and an image forming device of an inkjet printing system that forms an image using ink may be adopted.

The document conveying device 110 conveys a document D on which an image has already been formed toward the document reading device 102. The document reading device 102 optically reads an image formed on the document D conveyed by the document conveying device 110, and generates image data. As a reading element of the document reading device 102, for example, a charge-coupled device (CCD) sensor or a complementary metal oxide semiconductor (CMOS) can be used.

The feed tray 112 stores a plurality of sheets S that are stacked on top of each other. The feeding roller 197 feeds the sheets S, which are stored in the feed tray 112, toward the image forming device 115 on a one-by-one basis. The image forming device 115 forms an image represented by image data generated by the document reading device 102 (or image data received from an external device via a communication network) on the sheet S fed by the feeding roller 197. The image forming device 115 is provided with a writing device 103, image forming units 104Y, 104M, 104C, and 104K, an intermediate transfer belt 178, and a secondary transfer roller 189.

The writing device 103 converts an image represented by the image data into respective laser beams of a plurality of colors (e.g., yellow, magenta, cyan, and black) and irradiates the photoconductor drums 105Y, 105M, 105C, and 105K of the image forming units 104Y, 104M, 104C, and 104K with the laser beams. As a result, images of the corresponding colors are formed on the surfaces of the photoconductor drums 105Y, 105M, 105C, and 105K. To form a color image, corresponding color images formed on the photoconductor drums 105Y, 105M, 105C, and 105K are superimposed on top of one another and transferred onto the intermediate transfer belt 178. The secondary transfer roller 189 transfers the color image, which has been formed on the intermediate transfer belt 178, onto the sheet S fed by the feeding roller 197 and conveys the sheet S to the fixing device 120.

The fixing device 120 fixes the image, which has been transferred onto the sheet S by the secondary transfer roller 189, on the sheet S and conveys the sheet S to the conveyance roller pairs 131 and 132. The conveyance roller pair 131 conveys the sheet S, which has passed through the fixing device 120, toward the binding apparatus 30 installed in the in-body space W. The conveyance roller pair 132 conveys the sheet S that has passed through the fixing device 120 toward the first output tray 135 or the binding apparatus 30. Alternatively, the conveyance roller pair 132 reverses the front and rear sides of the sheet S, which has passed through the fixing device 120, through a reverse conveyance path 136 and supplies the sheet S to the image forming device 115 again. The destination of the sheet S that has passed through the fixing device 120 is switched by, for example, an operation made by a user through the operation panel 149 (or through an instruction from an external device).

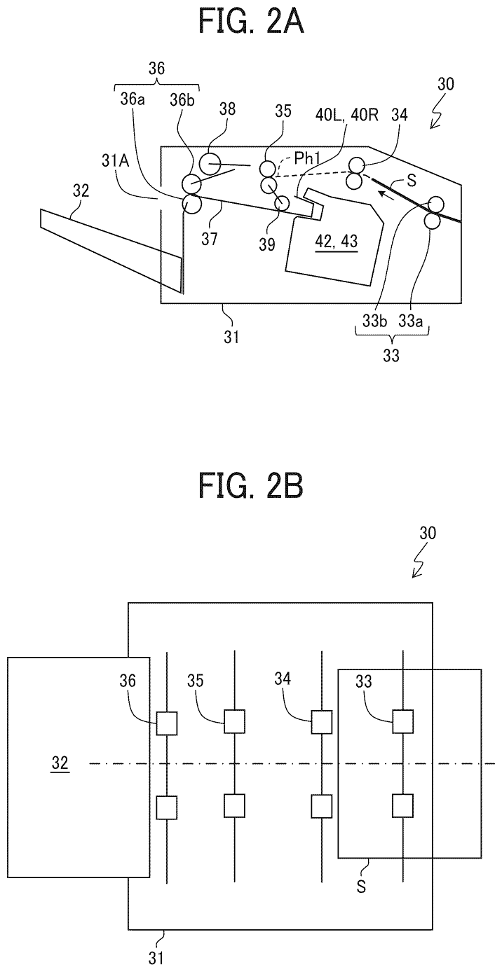

FIG. 2A is a side view of the binding apparatus 30, illustrating the internal structure of the binding apparatus 30, and FIG. 2B is a plan view of the binding apparatus 30, illustrating the position of a conveyance path Ph1.

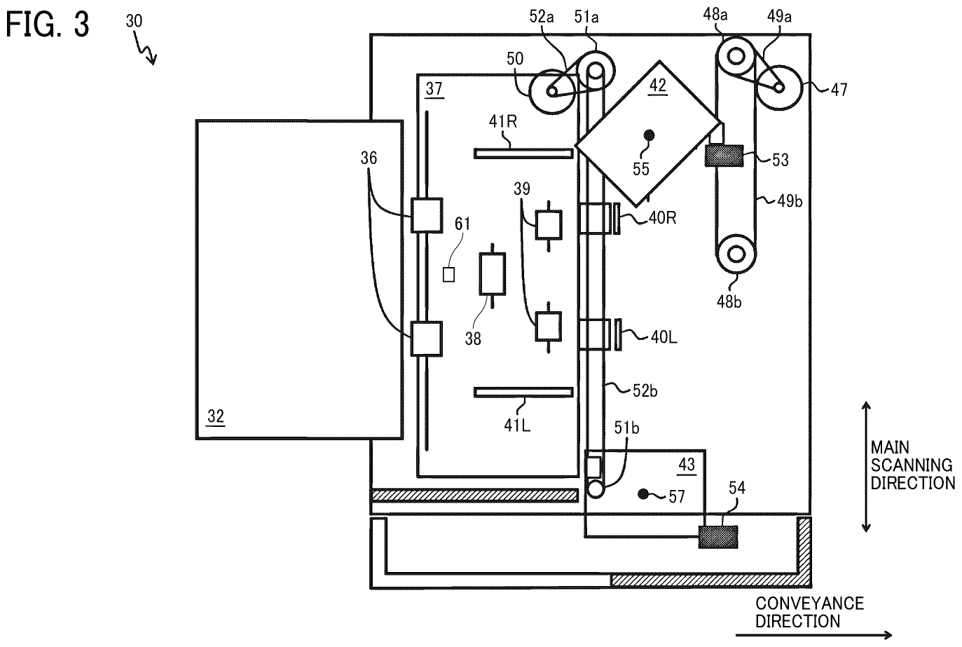

FIG. 3 is a plan view of the binding apparatus 30, illustrating the location of an internal tray 37 therein.

The binding apparatus 30 performs binding (post-processing) that binds multiple sheets S (sheet bundle Sb) on which images are formed by the image forming device 115. As illustrated in FIG. 2 and FIG. 3, the binding apparatus 30 includes a binding case (housing) 31, the second output tray 32, a plurality of conveyance roller pairs 33, 34, 35, and 36, the internal tray 37 that is an example of a container, a tapping roller 38, a return roller 39, end fences 40L and 40R, side fences 41L and 41R, a crimp binding device 42, and a stapler 43.

In the following description, a direction in which the sheet S proceeds to the end fence 40L and the end fence 40R along the top face of the internal tray 37 may be referred to as a conveyance direction. A direction orthogonal to the conveyance direction and the thickness direction of the sheet S supported on the internal tray 37, which is parallel to the width direction of the sheet S, is referred to as the “main scanning direction.”

The binding case 31 has a box shape to form an internal space for accommodating components of the binding apparatus 30. The conveyance path Ph1 as a space through which the sheet S passes is formed in the internal space of the binding case 31. The second output tray 32 is supported on the outer side face of the binding case 31. On the second output tray 32, the sheet S or the sheet bundle Sb that is conveyed by the conveyance roller pairs 33 to 36 is stacked.

The conveyance roller pairs 33 to 36 are arranged on the conveyance path Ph1 at given intervals. The conveyance roller pairs 33 to 36 convey the sheet S along the conveyance path Ph1. The conveyance roller pair 33 includes a drive roller 33a and a driven roller 33b that face each other across the conveyance path Ph1. The drive roller 33a and the driven roller 33b are rotatably supported by the binding case 31. When the driving force for rotation is transmitted from a conveyance motor to the drive roller 33a, the drive roller 33a rotates forward in the direction of conveying the sheet S (e.g., a counterclockwise (CCW) direction in FIG. 2). The driven roller 33b is disposed facing the drive roller 33a across the conveyance path Ph1 and is driven by the rotation of the drive roller 33a. As the conveyance motor is driven with the drive roller 33a and the driven roller 33b nipping the sheet S, the sheet S is conveyed along the conveyance path Ph1.

A basic configuration of the conveyance roller pairs 34 to 36 is common to the configuration of the conveyance roller pair 33. The conveyance roller pair 36 includes a drive roller 36a and a driven roller 36b that can be brought into contact with and separated from the drive roller 36a. The conveyance roller pair 35 may be slidable in the width direction in order to implement a sorting function to shift the sheet S in the width direction and ejecting the sheet S to the second output tray 32.

The internal tray 37 temporarily supports and holds multiple sheets S that are conveyed by the conveyance roller pair 36. The tapping roller 38 is supported at one end of a rotary arm above the internal tray 37. As the rotary arm rotates, the tapping roller 38 conveys the sheet S supplied to the internal tray 37 toward the end fence 40. The return roller 39 contacts the top face of the sheet S that is being conveyed toward the end fence 40 by the tapping roller 38, and rotates. Accordingly, the return roller 39 conveys the sheet S toward the end fence 40, and performs, for example, skew adjustment.

The end fences 40L and 40R contact a downstream end of the sheets S supported on the internal tray 37 in the conveyance direction and align the positions of the sheets S in the conveyance direction. The side fences 41L and 41R contact both ends of the sheet S supported on the internal tray 37 in the width direction to align the position of the sheets S in the main scanning direction. More specifically, the driving force of the fence motors 59L and 59R (see FIG. 11) is conveyed to the side fences 41L and 41R, and the side fences 41L and 41R can move independently of each other in the main scanning direction.

The binding apparatus 30 includes position sensors 60L and 60R (see FIG. 11). The position sensors 60L and 60R detect that the side fences 41L and 41R are located at standby positions in the main scanning direction. For example, the standby positions are positions where the distance in the main scanning direction is longest. In other words, the standby positions are positions wider than the maximum width of the sheet S, which can be accumulated in the internal tray 37, in the main scanning direction. For example, the position sensors 60L and 60R output position signals to the controller 160 when the side fences 41L and 41R are located at standby positions, and stop outputting position signals when the side fences 41L and 41R are located at positions different from the standby positions. The configuration of the position sensors 60L and 60R is not limited to any particular configuration, and for example, mechanical sensors, optical sensors, or magnetic sensors can be employed. The same applies to the other sensors.

The crimp binding device 42 and the stapler 43, which may collectively be referred to as a binding device, are disposed at positions at the downstream end of the sheet bundle Sb, which is supported on the internal tray 37, in the first conveyance direction. The crimp binding device 42 is, for example, a crimp binding device that presses and deforms a sheet bundle Sb to bind the sheet bundle Sb. The stapler 43 is, for example, a stapler that cause a staple N to penetrate the sheet bundle Sb to bind the sheet bundle Sb. However, the binding apparatus 30 may include only one of the crimp binding device 42 and the stapler 43 or may include both of the crimp binding device 42 and the stapler 43.

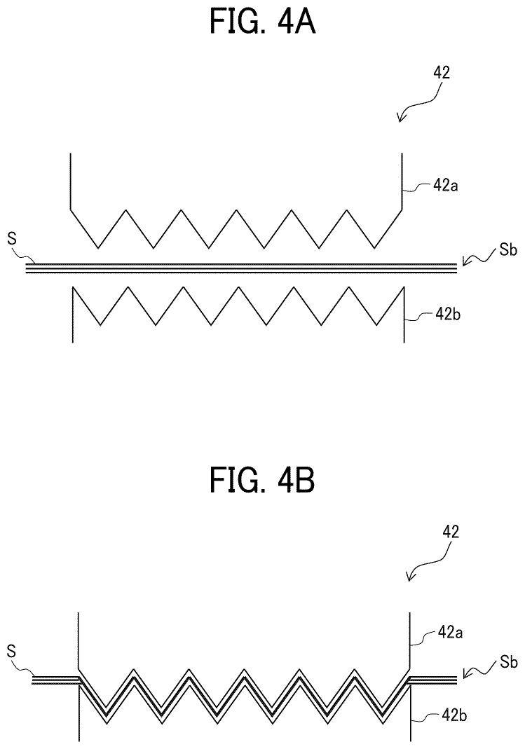

FIG. 4A and FIG. 4B are diagrams illustrating a configuration of the crimp binding device 42.

As illustrated in FIG. 4A and FIG. 4B, the crimp binding device 42 clamps the sheet bundle Sb in the thickness direction with a serrate upper crimping teeth 42a (first member) and a serrate lower crimping teeth 42b (second member) and presses and deforms the sheet bundle Sb to bind the sheet bundle Sb. In other words, the crimp binding device 42 is a staple-less binder that can bind the sheet bundle Sb without staples (N). The components of the crimp binding device 42 such as the upper crimping teeth 42a and the lower crimping teeth 42b are disposed on a crimping frame. In the following description, such a way of pressing and deforming the binding position of the sheet bundle Sb with the crimp binding device 42 to bind the sheet bundle Sb may be referred to simply as crimp binding.

The upper crimping teeth 42a and the lower crimping teeth 42b are disposed to face each other in the thickness direction of the sheet bundle Sb to nip the sheet bundle Sb placed on the internal tray 37. The upper crimping teeth 42a and the lower crimping teeth 42b have respective serrate faces facing each other. The serrate face of each of the upper crimping teeth 42a and the lower crimping teeth 42b includes concave portions and convex portions alternately formed. The concave portions and the convex portions of the upper crimping teeth 42a are shifted from those of the lower crimping teeth 42b such that the upper crimping teeth 42a mesh with the lower crimping teeth 42b. The upper crimping teeth 42a and the lower crimping teeth 42b contact and detach from each other by the driving force of a contact-separation motor.

In the processes where the multiple sheets S that make up the sheet bundle Sb are supplied to the internal tray 37, the upper crimping teeth 42a and the lower crimping teeth 42b are separated from each other as illustrated in FIG. 4A. When all the sheets S that make up the sheet bundle Sb are placed on the internal tray 37, the upper crimping teeth 42a and the lower crimping teeth 42b engage with each other as illustrated in FIG. 4B by the driving force of the contact-separation motor to press and deform the sheet bundle Sb in the thickness direction. Accordingly, the sheet bundle Sb accumulated on the internal tray 37 is crimp-bound.

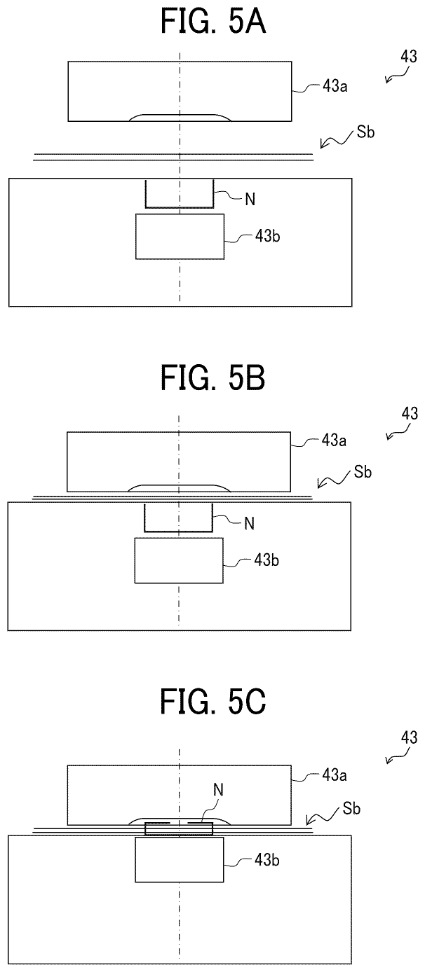

FIG. 5A, FIG. 5B, and FIG. 5C are diagrams illustrating a configuration of the stapler 43.

As illustrated in FIG. 5A, FIG. 5B, and FIG. 5C, the stapler 43 clamps the sheet bundle Sb and the staple N between an upper jaw 43a (first member) and a lower jaw 43b (second member), such that the staple N penetrates the sheet bundle Sb to bind the sheet bundle Sb. The components of the stapler 43 such as the upper jaw 43a, the lower jaw 43b, and cartridges are provided for a stapling frame. In the following description, such a way of binding the binding position of the sheet bundle Sb with the stapler 43 to bind the sheet bundle Sb may be referred to simply as stapling.

The upper jaw 43a and the lower jaw 43b are disposed to face each other in the thickness direction of the sheet bundle Sb to nip the sheet bundle Sb placed on the internal tray 37. The lower jaw 43b is provided with a cartridge supplied with staples N. Such a cartridge is supplied with staples N with the edges (edgy feet) directed upward. The upper jaw 43a and the lower jaw 43b contact and detach from each other by the driving force of a contact-separation motor.

In the process where the multiple sheets S that make up the sheet bundle Sb are supplied to the internal tray 37, the upper jaw 43a and the lower jaw 43b are separated from each other as illustrated in FIG. 5A. When all the sheets S that make up the sheet bundle Sb are placed on the internal tray 37, as illustrated in FIG. 5B and FIG. 5C, the upper jaw 43a and the lower jaw 43b clamp the sheet bundle Sb and the staple N by the driving force of a contact-separation motor. Due to such a configuration, the edges of the staple N penetrate the sheet bundle Sb upward from below, and are bent by a clincher formed on the upper jaw 43a. As a result, the sheet bundle Sb is bound by the staple N.

The edges of the staple N that are bent by the clincher rise from the sheet bundle Sb, and the edges of the staple N that may be caught by user's hand, and thus it is desired that the staple N penetrate the sheet bundle Sb from the front side toward the rear side. In other words, it is desired that the sheet bundle Sb be placed on the internal tray 37 with the front side facing downward.

Inside the binding case 31, the crimp binding device 42 and the stapler 43 are located at positions separated from each other in the main scanning direction. In the following description, the space where the crimp binding device 42 is located may be referred to as a rear side in the main scanning direction, which is an example of one side, and the space where the stapler 43 is located may be referred to as a front side in the main scanning direction, which is an example of another side. The crimp binding device 42 and the stapler 43 move independently in the main scanning direction along the sheet bundle Sb supported on the internal tray 37. Moreover, the crimp binding device 42 and the stapler 43 pivot independently around a rotary shaft 55 and a rotary shaft 57, respectively, each of which extends in the thickness direction of the sheet S supported on the internal tray 37.

The crimp binding device 42 moves in the main scanning direction by a main-scanning motor 47, a driving pulley 48a, a driven pulley 48b, an annular seamless belt 49a, and an annular seamless belt 49b. The main-scanning motor 47 generates a driving force for moving the crimp binding device 42 in the main scanning direction. The driving pulley 48a and the driven pulley 48b are rotatably supported by the binding case 31 at positions away from each other in the main scanning direction. The annular seamless belt 49a is looped around the output shaft of the main-scanning motor 47 and the driving pulley 48a. The annular seamless belt 49b is looped around the driving pulley 48a and the driven pulley 48b. The crimp binding device 42 is attached to the annular seamless belt 49b.

The driving force of the main-scanning motor 47 is transmitted to the driving pulley 48a through the annular seamless belt 49a. The annular seamless belt 49b circulates around the driving pulley 48a and the driven pulley 48b in accordance with rotation of the driving pulley 48a. As a result, the crimp binding device 42 attached to the annular seamless belt 49b moves in the main scanning direction. The driving pulley 48a, the driven pulley 48b, and the annular seamless belt 49a, and the annular seamless belt 49b are an example of a driving-force transmission mechanism that transmits the driving force of the main-scanning motor 47 to the crimp binding device 42. However, the specific configuration of the driving force transmission assembly is not limited to the above-described example. is not limited to the above-described examples.

The stapler 43 is moved in the main scanning direction by a main-scanning motor 50, a driving pulley 51a, a driven pulley 51b, the annular seamless belt 52a, and the annular seamless belt 52b. The main-scanning motor 50 generates a driving force for moving the stapler 43 in the main scanning direction. The driving pulley 51a and the driven pulley 51b are rotatably supported by the binding case 31 at positions away from each other in the main scanning direction. The annular seamless belt 52a is looped around the output shaft of the main-scanning motor 50 and the driving pulley 51a. The annular seamless belt 52b is looped around the driving pulley 51a and the driven pulley 51b. The stapler 43 is attached to the annular seamless belt 52b.

The driving force of the main-scanning motor 50 is transmitted to the driving pulley 51a through the annular seamless belt 52a. The annular seamless belt 52b circulates around the driving pulley 51a and the driven pulley 51b in accordance with rotation of the driving pulley 51a. As a result, the stapler 43 attached to the annular seamless belt 52b moves in the main scanning direction. The driving pulley 51a, the driven pulley 51b, and the annular seamless belt 52a, and the annular seamless belt 52b are an example of a driving-force transmission mechanism that transmits the driving force of the main-scanning motor 50 to the stapler 43. However, the configuration of the driving-force transmission mechanism is not limited to the above-described example.

The binding apparatus 30 includes position sensors 53 and 54. The position sensor 53 and the position sensor 54 detect the positions of the crimp binding device 42 and the stapler 43, respectively, in the main scanning direction. The position sensor 53 and the position sensor 54 For example, the crimp binding device 42 and the stapler 43 are positioned at a predetermined location in the main scanning direction. When it is arranged at the home position, a position signal is output to the controller 160, and the output of the position signal is stopped when the crimp binding device 42 and the stapler 43 are arranged at a position different from the home position.

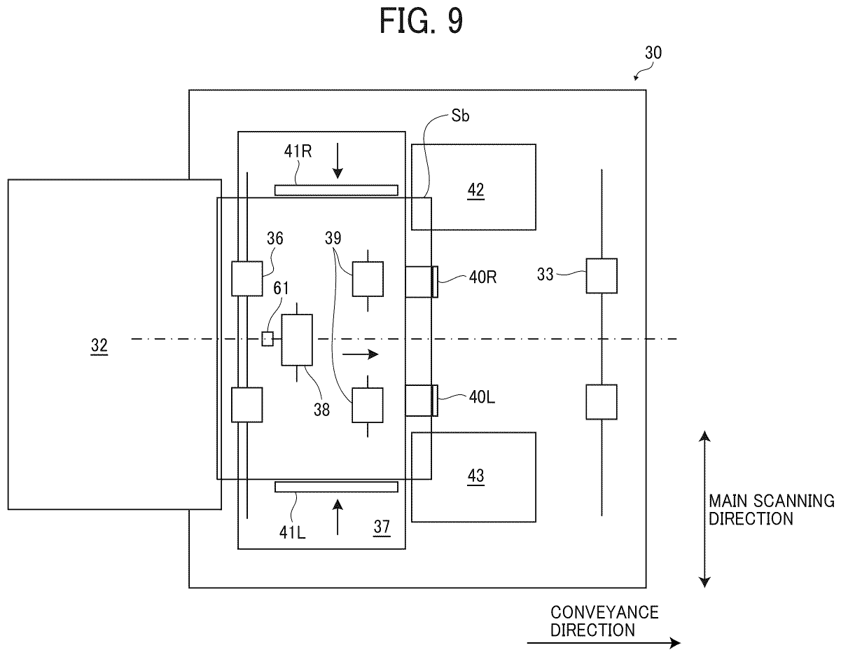

The crimp binding device 42 is supported on the binding case 31 so as to be pivotable around the rotary shaft 55 extending in the thickness direction of the sheet S supported on the internal tray 37. The crimp binding device 42 is driven by the driving force transmitted from the pivot motor 56 (see FIG. 11) to pivot between a parallel binding posture illustrated in FIG. 9 and an oblique binding posture illustrated in FIG. 3. In a similar manner to the above, the stapler 43 is driven by the driving force transmitted from the pivot motor 58 (see FIG. 11) to pivot around the rotary shaft 57 extending in the thickness direction of the sheet S supported on the internal tray 37.

The stapler 43 can staple any desired position of the sheet bundle Sb placed on the internal tray 37 in the main scanning direction. In other words, the range of movement of the stapler 43 in the main scanning direction covers the entirety of the sheet bundle Sb of the maximum width mountable on the internal tray 37. By contrast, the crimp binding device 42 can crimp only a rear portion (typically, a rear end) of the sheet bundle Sb placed on the internal tray 37 in the main scanning direction. Accordingly, the range of movement of the crimp binding device 42 in the main scanning direction is limited to an area facing a rear end of the sheet bundle Sb of varying width (between minimum width and maximum width) mountable on the internal tray 37. In other words, the range of movement of the crimp binding device 42 in the main scanning direction is narrower than the range of movement of the stapler 43 in the main scanning direction.

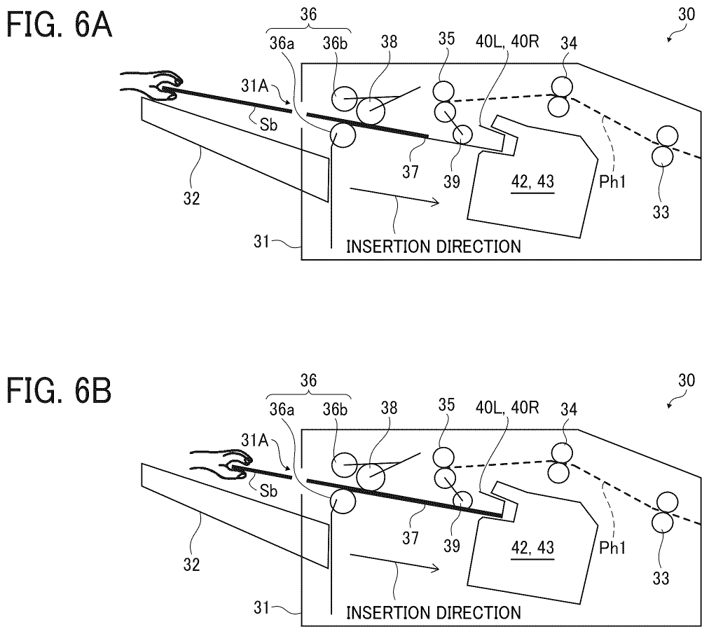

FIG. 6A and FIG. 6B are diagrams illustrating how the sheet bundle Sb is manually fed through an opening 31A.

As illustrated in FIG. 2A, FIG. 6A, and FIG. 6B, the opening 31A is formed on the binding case 31. More specifically, the opening 31A is formed on the side face of the binding case 31 that supports the second output tray 32, and is located above the second output tray 32. The sheet S that has been conveyed by the conveyance roller pair 36 or the sheet bundle Sb is ejected to the second output tray 32 through the opening 31A.

Through the opening 31A, the sheet bundle Sb is externally inserted into the binding case 31. More specifically, the sheet bundle Sb is inserted into the internal tray 37 through the space between the separated conveyance roller pair 36. Such a way of feeding may be referred to as manual feeding. In other words, as illustrated in FIG. 6A and FIG. 6B, the sheet bundle Sb that is inserted into the binding case 31 through the opening 31A passes through the space between the separated conveyance roller pair 36 and along the top face of the internal tray 37, and reaches the end fences 40L and 40R to face the crimp binding device 42 and the stapler 43. The insertion direction of the sheet bundle Sb that is inserted into the binding case 31 through the opening 31A matches the conveyance direction. The position of the opening 31A is not limited to the positions illustrated in FIG. 2A, FIG. 6A, and FIG. 6B, and may be at the front of the binding case 31 where the stapler 43 is located.

Further, as illustrated in FIG. 3, the binding apparatus 30 is provided with a sheet sensor 61. The sheet sensor 61 is located at a position where the sheet S or the sheet bundle Sb placed on the internal tray 37 is detectable. When the sheet bundle Sb is detected, the sheet sensor 61 outputs a detection signal to the controller 160. When the sheet bundle Sb is not detected, the sheet sensor 61 stops outputting a detection signal. The sheet sensor 61 can detect both the sheet bundle Sb manually feed through the opening 31A and the sheet S supplied from the image forming apparatus 1 and conveyed to the internal tray 37 by the conveyance roller pairs 33, 34, and 35.

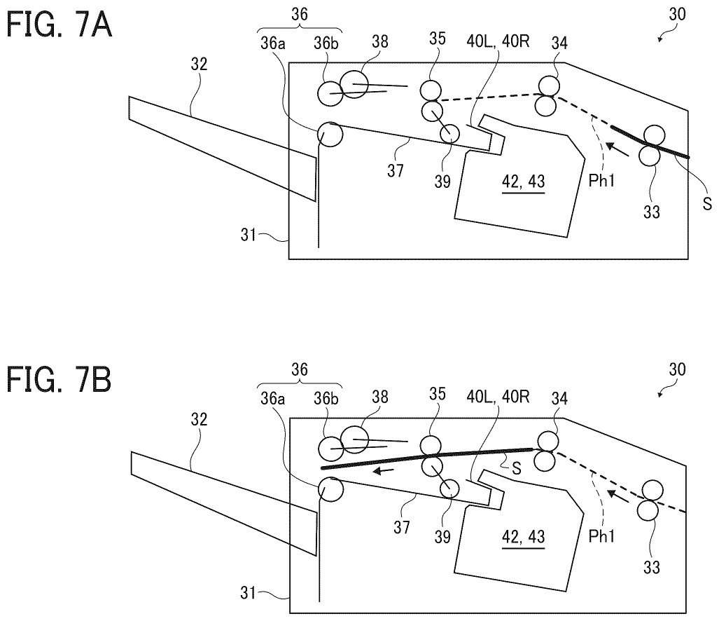

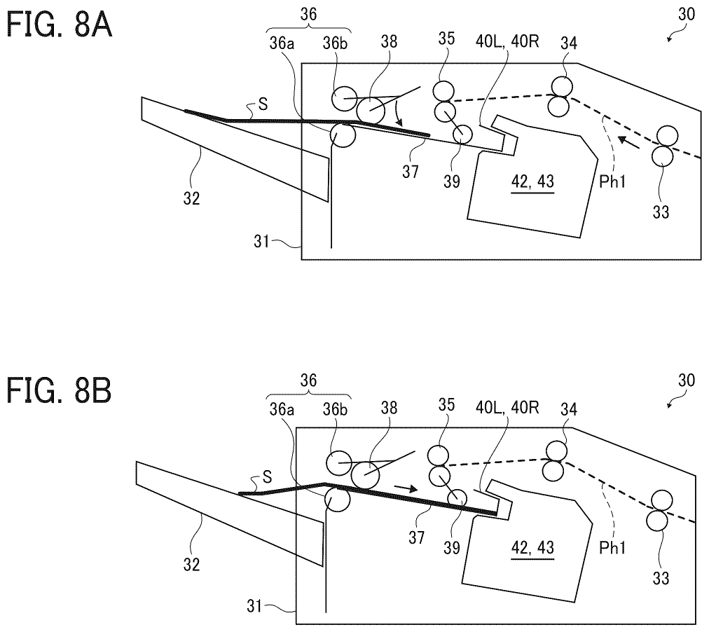

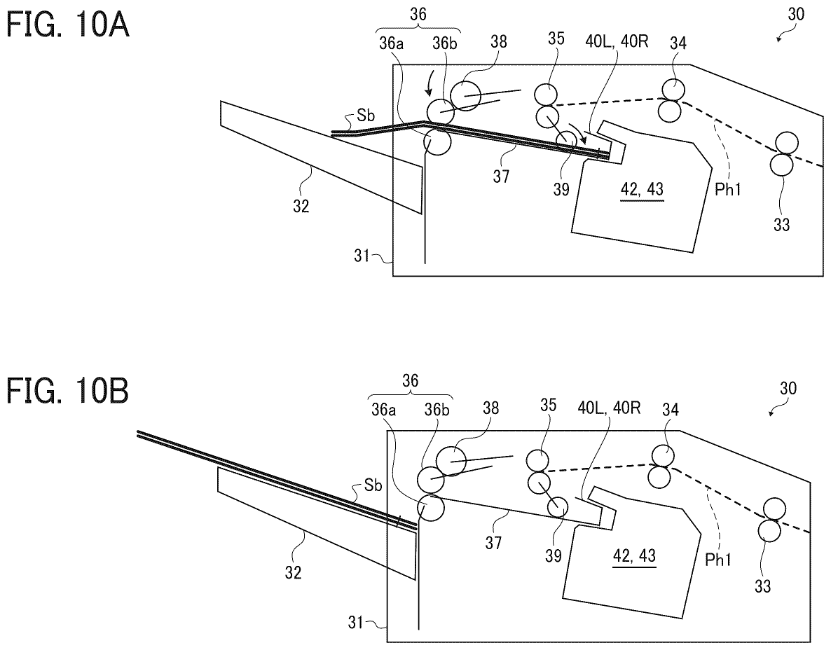

How binding is performed is described below with reference to FIG. 7A, FIG. 7B, FIG. 8A, FIG. 8B, FIG. 9, FIG. 10A, and FIG. 10B.

FIG. 7A and FIG. 7B are diagrams illustrating the binding apparatus 30 and how the sheet S passes through or reaches the conveyance roller pair 36.

FIG. 8A and FIG. 8B are diagrams illustrating how the binding apparatus 30 performs binding.

FIG. 9 is a diagram illustrating the binding apparatus 30 of FIG. 8B as viewed in the thickness direction of the sheet S.

FIG. 10A and FIG. 10B are diagrams illustrating the binding apparatus 30 that ejects the sheet bundle Sb having been subjected to a binding operation to the second output tray 32.

As illustrated in FIG. 7A and FIG. 7B, the binding apparatus 30 rotates the conveyance roller pair 33, the conveyance roller pair 34, and the conveyance roller pair 35 in the forward direction to conveys the sheet S supplied from the image forming device 115 along the conveyance path Ph1. At this moment in time, the drive roller 36a and the driven roller 36b of the conveyance roller pair 36 are separated from each other.

Subsequently, as illustrated in FIG. 8A and FIG. 8B, the binding apparatus 30 causes the tapping roller 38 to contact the sheet S that has passed through the conveyance roller pair 35, and causes the tapping roller 38 to rotate store the sheet S in the internal tray 37. As illustrated in FIG. 9, downstream ends of the sheets S, which are accumulated on the internal tray 37, in the first conveyance direction contact the end fences 40L and 40R, and thus the positions of the sheets S in the conveyance direction are aligned. Furthermore, the binding apparatus 30 moves the side fences 41L and 41R in the main scanning direction to align the positions of the sheets S stored in the internal tray 37 in the main scanning direction, and such an operation may be referred to as jogging. The binding apparatus 30 repeats the operations illustrated in FIG. 7A, FIG. 7B, FIG. 8A, FIG. 8B, and FIG. 9 so as to form the sheet bundle Sb on the internal tray 37.

As illustrated in FIG. 10A, the binding apparatus 30 causes the binding device to face the binding position of the sheet bundle Sb in response to a given number of sheets S being stacked on the internal tray 37. The binding apparatus 30 drives the binding device so as to crimp the sheet bundle Sb supported on the internal tray 37. Furthermore, as illustrated in FIG. 10B, the binding apparatus 30 rotates the conveyance motor in the reverse direction to make the conveyance roller pair 36 to eject the sheet bundle Sb to the second output tray 32.

FIG. 11 is a block diagram illustrating a hardware configuration of the image forming system.

As illustrated in FIG. 11, the image forming system includes, for example, the controller 150 that is an example of a controller to control the operation of the image forming apparatus 1 and the controller 160 that is another example of a controller to control the operation of the binding apparatus 30. The controller 150 and the controller 160 cooperate to control the operation of the image forming system. The roles of the controller 150 and the controller 160 that will be described later in detail in terms of the processes are given as an example, and no limitation is indicated thereby. In other words, some of or all of the processes of the controller 150 may be executed by the controller 160, and some of or all of the processes of the controller 160 may be executed by the controller 150.

The controller 150 includes, for example, a central processing unit (CPU) 151, and a memory 152. The controller 160 includes, for example, a central processing unit (CPU) 161 and a memory 162. Each of the memory 152 and the memory 162 includes, for example, a read-only memory (ROM), a random-access memory (RAM), a hard disk drive (HDD), or a combination of those elements. The controller 150 causes the CPU 151 to read and execute the program code stored in the memory 152 to implement the processing as will be described later in detail. The controller 160 also causes the CPU 161 to read and execute the program code stored in the memory 162 to implement the processing as will be described later in detail. However, the configurations of the controller 150 and the controller 160 are not limited to the above-described configurations, and may be implemented with hardware such as application-specific integrated circuits (ASICs) or field-programmable gate arrays (FPGAs).

The controller 150 controls the operation of the elements of the image forming apparatus 1 (e.g., the feeding roller 197, the image forming device 115, the fixing device 120, the conveyance roller pairs 131 and 132, and the operation panel 149) through an internal interface 153. The controller 160 controls the operation of the elements of the binding apparatus 30 such as the conveyance roller pairs 33 to 36, the tapping roller 38, the return roller 39, the end fences 40L and 40R, the side fences 41L and 41R, the crimp binding device 42, the stapler 43, the position sensors 53, 54, 60L, and 60R, the sheet sensor 61, and rotary encoders 47a, 50a, 56a, 58a, 59La, and 59Ra through an internal interface 163. The components or elements illustrated in FIG. 11 are driven by a motor that is an example of a driving source, and the state of operation such as the position or orientation is detected by a sensor.

The control panel 149 includes an input device that receives inputs from a user and a display that is an example of a notifying device to notify a user of information. The input device includes, for example, hard keys and a touch panel overlaid on the display. Th operation panel 149 acquires information from the operator through an input unit and provides the operator with information through the display. A concrete example of the input device is not limited to a hard key or a touch panel, and may be any kind of device that accepts instructions by voice. A concrete example of the notifying device is not limited to a display and may be a light-emitting diode (LED) lamp or a loudspeaker.

The rotary encoders 47a, 50a, 56a, 58a, 59La, and 59Ra detect the amount of movement or revolutions per minute (rpm) of the main-scanning motors 47 and 50, the pivot motors 56 and 58, and the fence motors 59L and 59R, respectively. More specifically, the rotary encoders 47a, 50a, 56a, 58a, 59La, and 59Ra output pulse signals to the controller 160 in accordance with the rotations of the main-scanning motors 47 and 50, the pivot motors 56 and 58, and the fence motors 59L and 59R. The controller 160 counts the number of the pulse signals output from the rotary encoders 47a, 50a, 56a, 58a, 59La, and 59Ra to know the amount of movement of the main-scanning motors 47 and 50, the pivot motors 56 and 58, and the fence motors 59L and 59R, respectively.

The controller 160 monitors the current position of the crimp binding device 42 in the main scanning direction based on the detection results of the position sensor 53 in combination with the detection results of the rotary encoder 47a. In other words, the position sensor 53 and the rotary encoder 47a are combined to detect the position of the crimp binding device 42 in the main scanning direction. In a similar manner to the above, the controller 160 monitors the current position of the stapler 43 in the main scanning direction based on the detection results of the position sensor 54 in combination with the detection results of the rotary encoder 50a. In other words, the position sensor 54 and the rotary encoder 50a are combined to detect the position of the stapler 43 in the main scanning direction.

The controller 160 monitors the current positions of the side fences 41L and 41R in the main scanning direction based on the detection results of the position sensors 60L and 60R in combination with the detection results of the rotary encoders 59La and 59Ra. In other words, the position sensors 60L and 60R and the rotary encoders 59La and 59Ra are combined to detect the position of the side fences 41L and 41R in the main scanning direction.

Furthermore, the controller 150 and the controller 160 are coupled to each other through an external interface 154 and an external interface 164 to communicate with each other. The controller 150 and the controller 160 cooperate to control the operation of the multiple elements based on the information transmitted and received through the external interface 154 and the external interface 164.

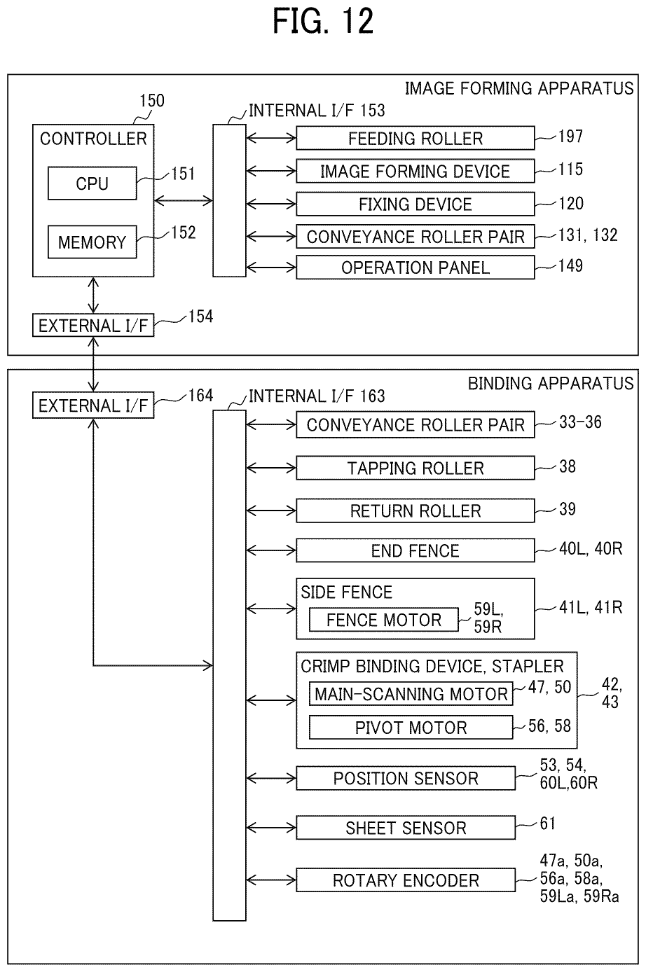

FIG. 12 is another block diagram illustrating a hardware configuration of the image forming system.

FIG. 12 is different from FIG. 11 in that the controller 160 of the binding apparatus 30 is omitted, and is the same as FIG. 11 in the other points.

The controller 150 illustrated in FIG. 12, which is an example of a controller or processing circuitry, controls the operations of the components of the image forming apparatus 1A through the internal interface 153, and controls the operations of the components of the binding apparatus 30 through the external interface 154, the external interface 164, and the internal interface 163. In other words, the binding apparatus 30 illustrated in FIG. 12 operates under the control of the controller 150 installed in the main unit of the image forming apparatus 1A.

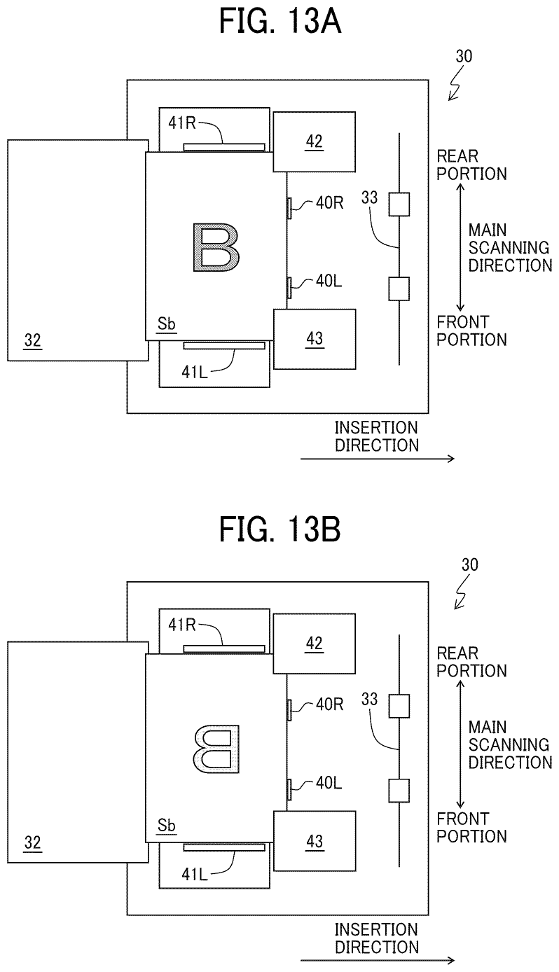

FIG. 13A and FIG. 13B are diagrams illustrating how the sheet bundle Sb is manually fed with long-edge feed (LEF).

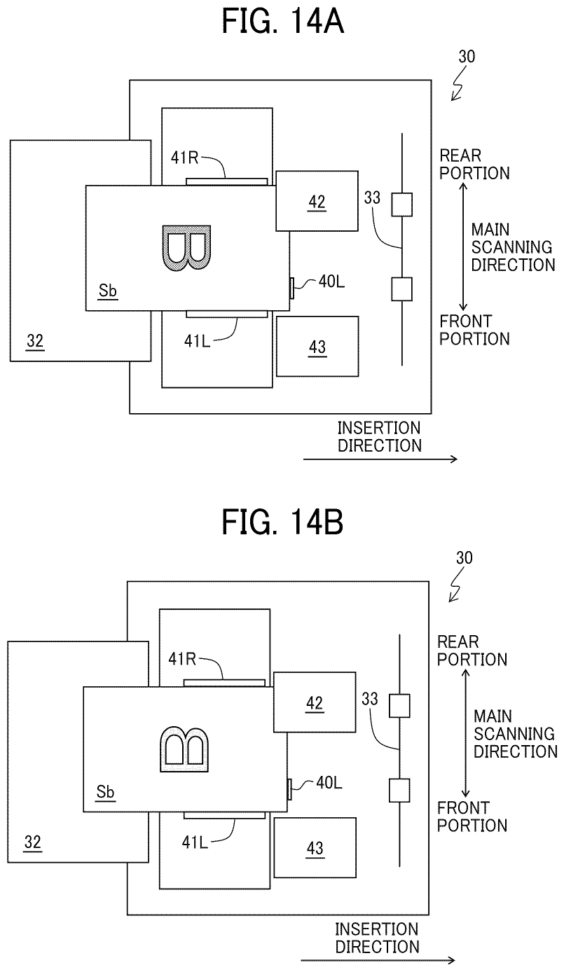

FIG. 14A and FIG. 14B are diagrams illustrating how the sheet bundle Sb is manually fed with short-edge feed (SEF).

The sheet bundle Sb according to the present embodiment is a bundle of rectangular sheets S with shorter sides and longer sides. On the sheets S that make up the sheet bundle Sb, an image, e.g., “B” in FIG. 13A, FIG. 13B, FIG. 14A, and FIG. 14B, is formed. Such an image may be formed one of the front side and rear side of the sheets S, or may be formed on both of the front side and rear side of the sheets S. Moreover, an image may be formed on some of the multiple sheets S that make up the sheet bundle Sb, or may be formed on all of the multiple sheets S that make up the sheet bundle Sb. Of both sides of the sheet bundle Sb in the thickness direction, one with the first sheet S, i.e., the first page, may be referred to as the front side of the sheet bundle Sb, and one with the last sheet S, i.e., the last page, may be referred to as the rear side of the sheet bundle Sb. The front side and rear side of the sheet bundle Sb are determined by the images formed on the sheet bundle Sb.

The number of sheets of the sheets S that make up the sheet bundle Sb manually feed through the opening 31A may be referred to as the number of sheets to be bound. For example, the number of sheets that can be crimp-bound is 2 to 10, and the number of sheets that can be stapled is 2 to 50. In other words, the maximum number of sheets that can be crimp-bound, i.e., 10, is smaller than the maximum number of sheets that can be stapled, i.e., 50.

Moreover, the size of the sheets S (e.g., A4, A3, B5, and B4) that make up the sheet bundle Sb manually feed through the opening 31A may be referred to as a sheet size (which is an example of a medium size). The sheet size includes a “small size” (e.g., A4 and B5) where long-edge feed (LEF) is selectable and a sheet can be manually fed with the longer side parallel to the main scanning direction and a “large size” (e.g., A3 and B4) where a sheet cannot be manually fed with the longer side parallel to the main scanning direction and short-edge feed (SEF) is selectable only when a sheet is manually fed with the shorter side parallel to the main scanning direction. In other words, a large size indicates that the width of a sheet in the main scanning direction is wider than the maximum space between the side fences 41L and 41R when the side fences 41L and 41R are at the standby positions.

The manual-feeding orientations indicates the orientation of the sheet bundle Sb that is manually fed into the binding case 31 through the opening 31A. For example, the manual-feeding orientation indicates a combination of the insertion orientation of the sheet bundle Sb when manually fed through the opening 31A, the image orientation of the image on the sheet bundle Sb when manually fed through the opening 31A, and the front-rear orientation of the sheet bundle Sb when manually fed through the opening 31A.

The insertion orientation indicates the orientation of the longer side and shorter side of the sheet bundle Sb manually feed through the opening 31A. The insertion orientation is one of short-edge feed (SEF) where the longer side is parallel to the insertion direction and the shorter side is parallel to the main scanning direction and long-edge feed (LEF) where the shorter side is parallel to the insertion direction and the longer side is parallel to the main scanning direction.

The image orientation indicates the orientation of the image formed on the sheets S, which make up the sheet bundle Sb, when the sheet bundle Sb is manually fed. For the image that is formed on the sheet S (e.g., characters, numbers, symbols, illustrations, and photographs), the up-and-down orientation is determined in advance. The image orientation is one of 0°, 90°, 180°, and 270°. The image orientation 0°indicate that an upper portion of the image is directed toward the recess side in the main scanning direction. The image orientations 90°, 180°, and 270° indicate that the image is rotated clockwise by 90°, 180°, and 270°, respectively, with reference to the image orientation 0° around an axis orthogonal to the thickness direction of the sheet bundle Sb.

The front-rear orientation indicates the orientation of the front side and rear side of the sheet bundle Sb manually feed through the opening 31A. The front-rear orientation is one of a downward orientation where the front side of the sheet bundle Sb is directed downward so as to face the internal tray 37 and an upward orientation where the front side of the sheet bundle Sb is directed upward so as not to face the internal tray 37.

In FIG. 13A, the sheet bundle Sb is manually fed with a manual-feeding orientation where the insertion orientation is long-edge feed (LEF), the image orientation is 0°, and the front-rear orientation is an upward direction. In FIG. 13B, the sheet bundle Sb is manually fed with a manual-feeding orientation where the insertion orientation is long-edge feed (LEF), the image orientation is 0°, and the front-rear orientation is downward. In FIG. 14A, the sheet bundle Sb is manually fed with a manual-feeding orientation where the insertion orientation is short-edge feed (SEF), the image orientation is 90°, and the front-rear orientation is an upward direction. In FIG. 14B, the sheet bundle Sb is manually fed with a manual-feeding orientation where the insertion orientation is short-edge feed (SEF), the image orientation is 90°, and the front-rear orientation is downward.

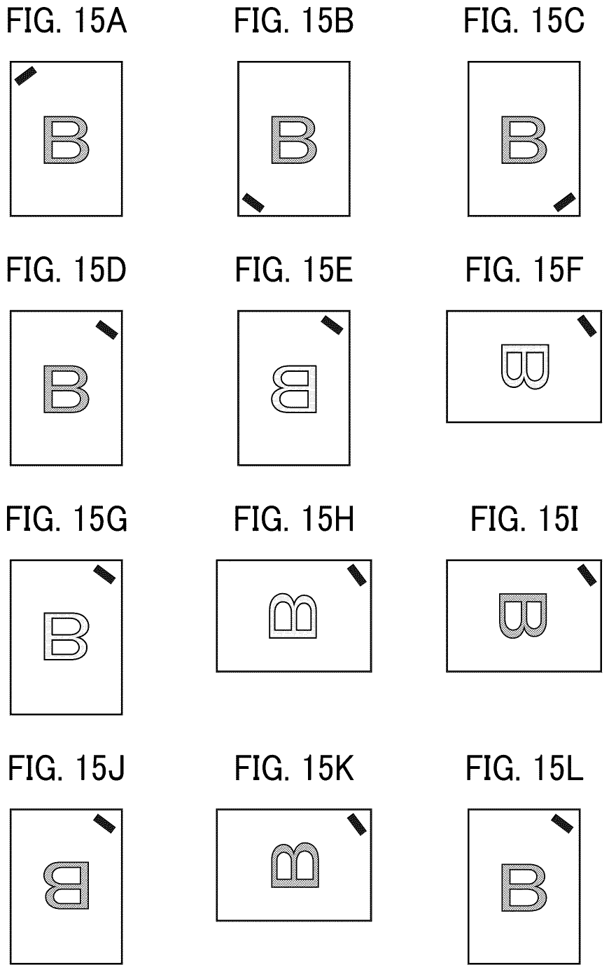

FIG. 15A to FIG. 15L are diagrams illustrating a combination of manual-feeding orientations of the sheet bundle Sb and variations of binding positions by crimp binding on the sheet bundle Sb.

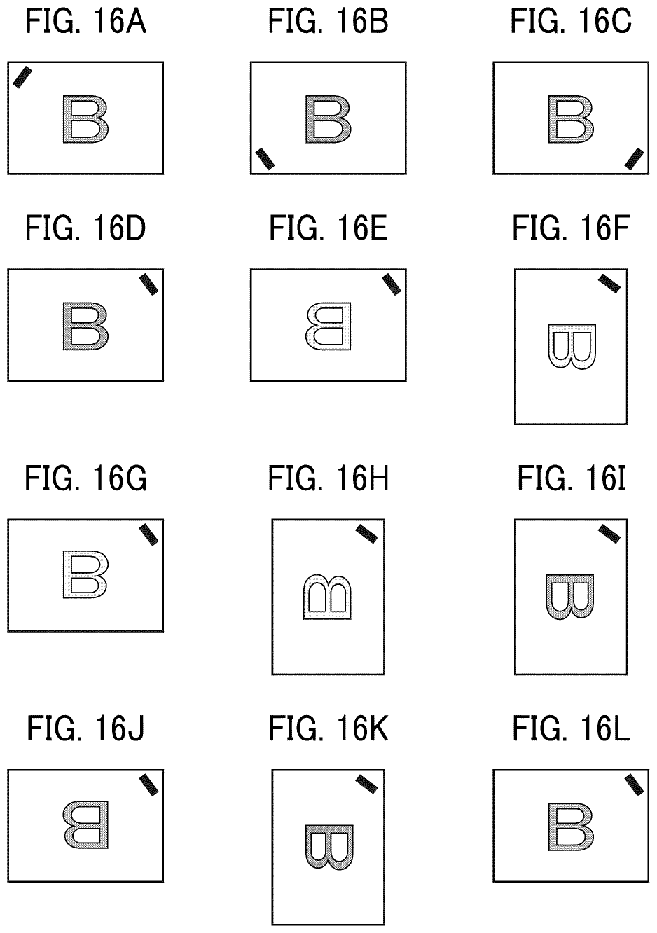

FIG. 16A to FIG. 16L are other diagrams illustrating a combination of manual-feeding orientations of the sheet bundle Sb and variations of binding positions by crimp binding on the sheet bundle Sb.

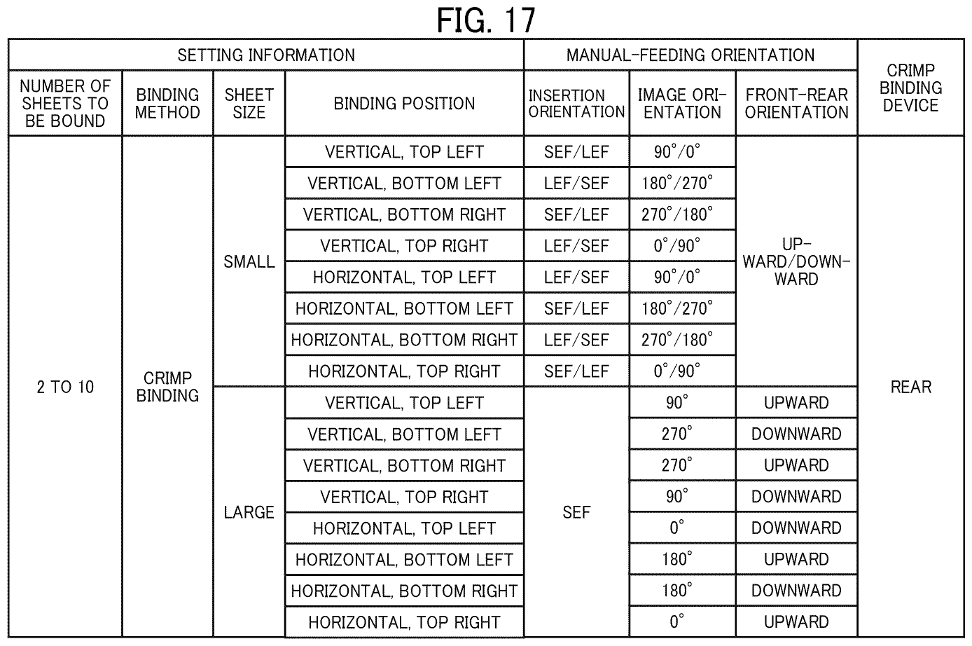

FIG. 17 is a table indicating combinations of the setting data input by a user (e.g., the number of sheets to be bound, a binding method, a sheet size, and a binding position), manual-feeding orientations (e.g., an insertion orientation, an image orientation, a front-rear orientation), and the position of the crimp binding device 42 in the main scanning direction.

In FIG. 15E to FIG. 15L and FIG. 16E to FIG. 16L, a downstream portion of a sheet in the insertion direction is on the right side, and a rear portion of a sheet in the main scanning direction is on the upper side.

FIG. 15A to FIG. 15D illustrate vertical sheets where the longer side of the sheet bundle Sb is parallel to the vertical direction of an image. FIG. 15A indicates a sheet whose top-left corner of the sheet bundle Sb is crimp-bound. FIG. 15B indicates a sheet whose bottom-left corner of the sheet bundle Sb is crimp-bound. FIG. 15C indicates a sheet whose bottom-right corner of the sheet bundle Sb is crimp-bound. FIG. 15D indicates a sheet whose top-right corner of the sheet bundle Sb is crimp-bound. The binding position in FIG. 15A is referred to as a vertical, top-left position in the following description. The binding position in FIG. 15B is referred to as a vertical, bottom-left position in the following description. The binding position in FIG. 15C is referred to as a vertical, bottom-right position in the following description. The binding position in FIG. 15D is referred to as a vertical, top-right position in the following description.

The manual-feeding orientation when a vertical, top-left portion of the sheet bundle Sb is crimp-bound as illustrated in FIG. 15A is selectable between the orientation illustrated in FIG. 15E where the insertion orientation is long-edge feed (LEF), the image orientation is 0°, and the front-rear orientation is downward and the orientation illustrated in FIG. 15I where the insertion orientation is short-edge feed (SEF), the image orientation is 90°, and the front-rear orientation is an upward direction. The manual-feeding orientation when a vertical, bottom-left portion of the sheet bundle Sb is crimp-bound as illustrated in FIG. 15B is selectable between the orientation illustrated in FIG. 15F where the insertion orientation is short-edge feed (SEF), the image orientation is 270°, and the front-rear orientation is downward and the orientation illustrated in FIG. 15E where the insertion orientation is long-edge feed (LEF), the image orientation is 180°, and the front-rear orientation is an upward direction. The manual-feeding orientation when a vertical, bottom-right portion of the sheet bundle Sb is crimp-bound as illustrated in FIG. 15C is selectable between the orientation illustrated in FIG. 15G where the insertion orientation is long-edge feed (LEF), the image orientation is 180°, and the front-rear orientation is downward and the orientation illustrated in FIG. 15K where the insertion orientation is short-edge feed (SEF), the image orientation is 270°, and the front-rear orientation is an upward direction. The manual-feeding orientation when a vertical, top-right portion of the sheet bundle Sb is crimp-bound as illustrated in FIG. 15D is selectable between the orientation illustrated in FIG. 15H where the insertion orientation is short-edge feed (SEF), the image orientation is 90°, and the front-rear orientation is downward and the orientation illustrated in FIG. 15L where the insertion orientation is long-edge feed (LEF), the image orientation is 0°, and the front-rear orientation is an upward direction.

FIG. 16A to FIG. 16D illustrate horizontal sheets where the shorter side of the sheet bundle Sb is parallel to the vertical direction of an image. FIG. 16A indicates a sheet whose top-left corner of the sheet bundle Sb is crimp-bound. FIG. 16B indicates a sheet whose bottom-left corner of the sheet bundle Sb is crimp-bound. FIG. 16C indicates a sheet whose bottom-right corner of the sheet bundle Sb is crimp-bound. FIG. 16D indicates a sheet whose top-right corner of the sheet bundle Sb is crimp-bound.

The binding position in FIG. 16A is referred to as a horizontal, top-left position in the following description. The binding position in FIG. 16B is referred to as a horizontal, bottom-left position in the following description. The binding position in FIG. 16C is referred to as a horizontal, bottom-right position in the following description. The binding position in FIG. 16D is referred to as a horizontal, top-right position in the following description.

The manual-feeding orientation when a horizontal, top-left portion of the sheet bundle Sb is crimp-bound as illustrated in FIG. 16A is selectable between the orientation illustrated in FIG. 16E where the insertion orientation is short-edge feed (SEF), the image orientation is 0°, and the front-rear orientation is downward and the orientation illustrated in FIG. 16I where the insertion orientation is long-edge feed (LEF), the image orientation is 90°, and the front-rear orientation is an upward direction. The manual-feeding orientation when a horizontal, bottom-left portion of the sheet bundle Sb is crimp-bound as illustrated in FIG. 16B is selectable between the orientation illustrated in FIG. 16F where the insertion orientation is long-edge feed (LEF), the image orientation is 270°, and the front-rear orientation is downward and the orientation illustrated in FIG. 16J where the insertion orientation is short-edge feed (SEF), the image orientation is 180°, and the front-rear orientation is an upward direction. The manual-feeding orientation when a horizontal, bottom-right portion of the sheet bundle Sb is crimp-bound as illustrated in FIG. 16C is selectable between the orientation illustrated in FIG. 16G where the insertion orientation is short-edge feed (SEF), the image orientation is 180°, and the front-rear orientation is downward and the orientation illustrated in FIG. 16K where the insertion orientation is long-edge feed (LEF), the image orientation is 270°, and the front-rear orientation is an upward direction. The manual-feeding orientation when a horizontal, top-right portion of the sheet bundle Sb is crimp-bound as illustrated in FIG. 16D is selectable between the orientation illustrated in FIG. 16H where the insertion orientation is long-edge feed (LEF), the image orientation is 90°, and the front-rear orientation is downward and the orientation illustrated in FIG. 16L where the insertion orientation is short-edge feed (SEF), the image orientation is 0°, the front-rear orientation is an upward direction.

When the sheet bundle Sb is to be crimp-bound, as illustrated in FIG. 17, the sheet bundle Sb is to be manually fed with a manual-feeding orientation where the binding position is at a downstream portion of the sheet bundle Sb in the insertion direction and a rear portion of the sheet bundle Sb in the main scanning direction, which are the top-right corners of sheets in FIG. 15A to FIG. 15L and FIG. 16A to FIG. 16L. When the sheet size is a small size, any one of the manual-feeding orientations in FIG. 15E to FIG. 15L and FIG. 16E to FIG. 16L can be selected. On the other hand, when the sheet size is a large size, only the manual-feeding orientations where the insertion orientation is short-edge feed (SEF) as in FIG. 15F, FIG. 15H, FIG. 15I, FIG. 15K, FIG. 16E, FIG. 16G, FIG. 16J, and FIG. 16L can be selected.

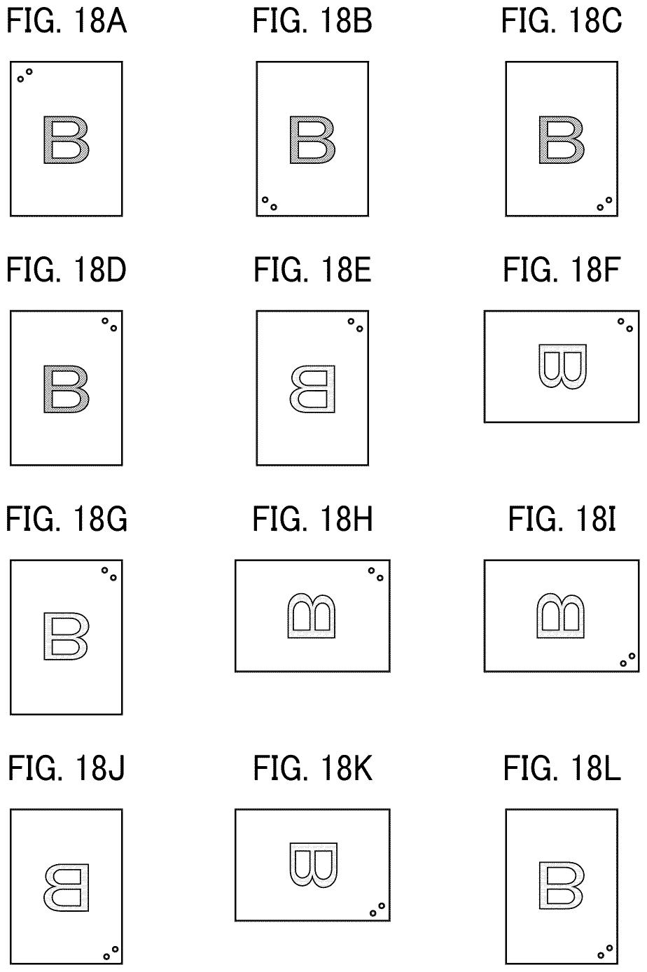

FIG. 18A to FIG. 18L are diagrams illustrating a combination of variations of binding positions by stapling on the sheet bundle Sb and manual-feeding orientations of the sheet bundle Sb.

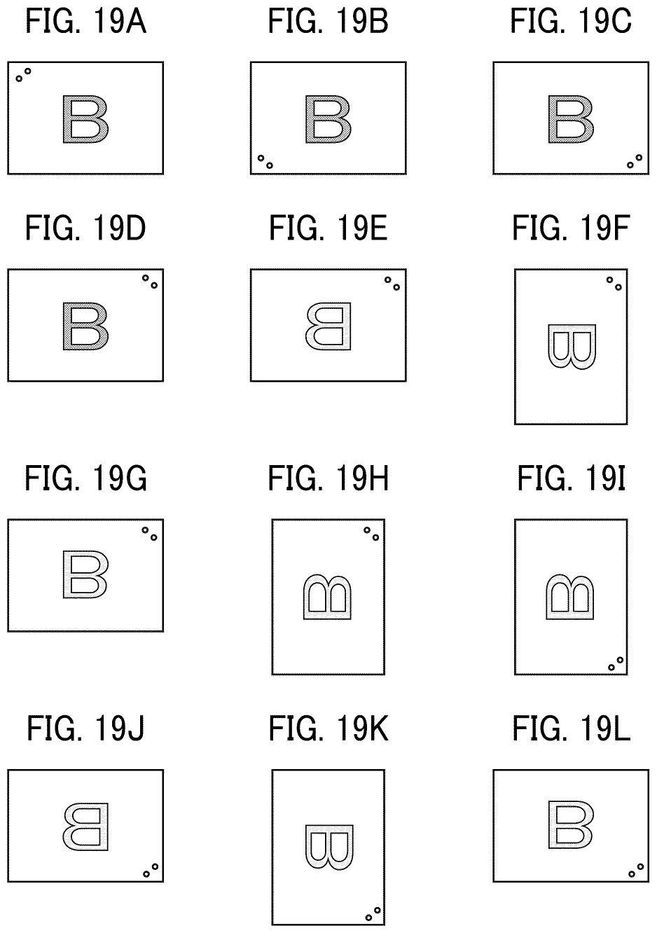

FIG. 19A to FIG. 19L are other diagrams illustrating a combination of manual-feeding orientations of the sheet bundle Sb and variations of binding positions by stapling on the sheet bundle Sb.

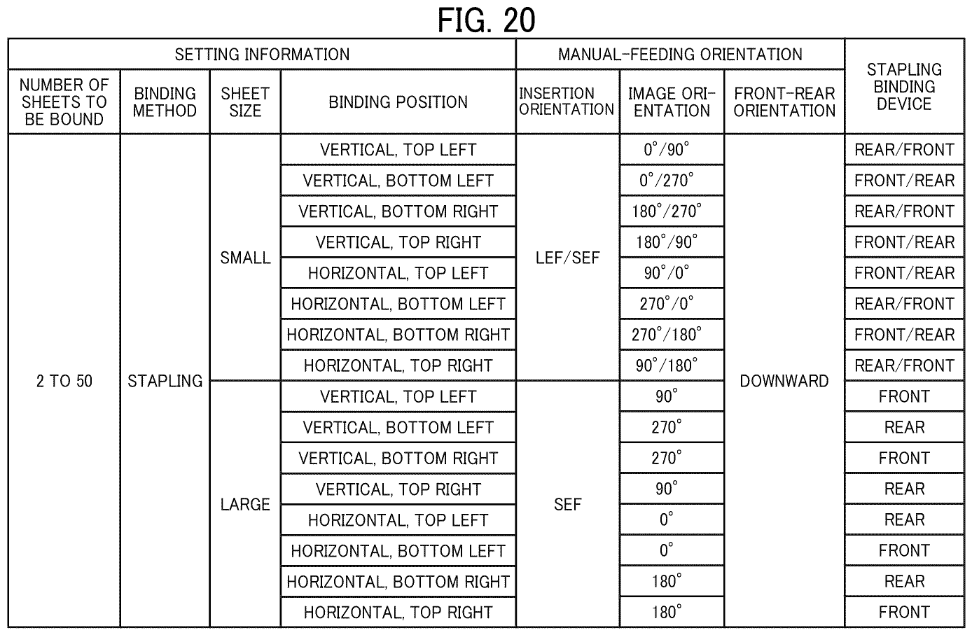

FIG. 20 is a table indicating combinations of the setting data input by a user (e.g., the number of sheets to be bound, a binding method, a sheet size, and a binding position), manual-feeding orientations (e.g., an insertion orientation, an image orientation, a front-rear orientation), and the position of the stapler 43 in the main scanning direction.

In FIG. 18E to FIG. 18L and FIG. 19E to FIG. 19L, a downstream portion of a sheet in the insertion direction is on the right side, and a rear portion of a sheet in the main scanning direction is on the upper side.

FIG. 18A to FIG. 18D illustrate vertical sheets where the longer side of the sheet bundle Sb is parallel to the vertical direction of an image. FIG. 18A indicates a sheet whose vertical, top-left position of the sheet bundle Sb is stapled. FIG. 18B indicates a sheet whose vertical, bottom-left position of the sheet bundle Sb is stapled. FIG. 18C indicates a sheet whose vertical, bottom-right position of the sheet bundle Sb is stapled. FIG. 18D indicates a sheet whose vertical, top-right position of the sheet bundle Sb is stapled.

The manual-feeding orientation when a vertical, top-left portion of the sheet bundle Sb is stapled as illustrated in FIG. 18A is selectable between the orientation illustrated in FIG. 18E where the insertion orientation is long-edge feed (LEF), the image orientation is 0°, and the front-rear orientation is downward and the orientation illustrated in FIG. 18I where the insertion orientation is short-edge feed (SEF), the image orientation is 90°, and the front-rear orientation is downward. The manual-feeding orientation when a vertical, bottom-left portion of the sheet bundle Sb is stapled as illustrated in FIG. 18B is selectable between the orientation illustrated in FIG. 18F where the insertion orientation is short-edge feed (SEF), the image orientation is 270°, and the front-rear orientation is downward and the orientation illustrated in FIG. 18J where the insertion orientation is long-edge feed (LEF), the image orientation is 0°, and the front-rear orientation is downward. The manual-feeding orientation when a vertical, bottom-right portion of the sheet bundle Sb is stapled as illustrated in FIG. 18C is selectable between the orientation illustrated in FIG. 18G where the insertion orientation is long-edge feed (LEF), the image orientation is 180°, and the front-rear orientation is downward and the orientation illustrated in FIG. 18K where the insertion orientation is short-edge feed (SEF), the image orientation is 270°, and the front-rear orientation is downward. The manual-feeding orientation when a vertical, top-right portion of the sheet bundle Sb is stapled as illustrated in FIG. 18D is selectable between the orientation illustrated in FIG. 18H where the insertion orientation is short-edge feed (SEF), the image orientation is 90°, and the front-rear orientation is downward and the orientation illustrated in FIG. 18L where the insertion orientation is long-edge feed (LEF), the image orientation is 180°, and the front-rear orientation is downward.

FIG. 19A to FIG. 19D illustrate horizontal sheets where the shorter side of the sheet bundle Sb is parallel to the vertical direction of an image. FIG. 19A indicates a sheet whose horizontal, top-left position of the sheet bundle Sb is stapled. FIG. 19B indicates a sheet whose horizontal, bottom-left position of the sheet bundle Sb is stapled. FIG. 19C indicates a sheet whose horizontal, bottom-right position of the sheet bundle Sb is stapled. FIG. 19D indicates a sheet whose horizontal, top-right position of the sheet bundle Sb is stapled.

The manual-feeding orientation when a horizontal, top-left portion of the sheet bundle Sb is stapled as illustrated in FIG. 19A is selectable between the orientation illustrated in FIG. 19E where the insertion orientation is short-edge feed (SEF), the image orientation is 0°, and the front-rear orientation is downward and the orientation illustrated in FIG. 19I where the insertion orientation is long-edge feed (LEF), the image orientation is 90°, and the front-rear orientation is downward. The manual-feeding orientation when a horizontal, bottom-left portion of the sheet bundle Sb is stapled as illustrated in FIG. 19B is selectable between the orientation illustrated in FIG. 19F where the insertion orientation is long-edge feed (LEF), the image orientation is 270°, and the front-rear orientation is downward and the orientation illustrated in FIG. 19J where the insertion orientation is short-edge feed (SEF), the image orientation is 0°, and the front-rear orientation is downward. The manual-feeding orientation when a horizontal, bottom-right portion of the sheet bundle Sb is stapled as illustrated in FIG. 19C is selectable between the orientation illustrated in FIG. 19G where the insertion orientation is short-edge feed (SEF), the image orientation is 180°, and the front-rear orientation is downward and the orientation illustrated in FIG. 19K where the insertion orientation is long-edge feed (LEF), the image orientation is 270°, and the front-rear orientation is downward. The manual-feeding orientation when a horizontal, top-right portion of the sheet bundle Sb is stapled as illustrated in FIG. 19D is selectable between the orientation illustrated in FIG. 19H where the insertion orientation is long-edge feed (LEF), the image orientation is 90°, and the front-rear orientation is downward and the orientation illustrated in FIG. 19L where the insertion orientation is short-edge feed (SEF), the image orientation is 180°, and the front-rear orientation is downward.

When the sheet bundle Sb is to be stapled, as illustrated in FIG. 20, the sheet bundle Sb is to be manually fed with a manual-feeding orientation where the front side of the sheet bundle Sb is directed downward and the binding position is at a downstream portion of the sheet bundle Sb in the insertion direction, which is on the right sides in FIG. 18A to FIG. 18L and FIG. 19A to FIG. 19L. When the sheet size is a small size, any one of the manual-feeding orientations in FIG. 18E to FIG. 18L and FIG. 19E to FIG. 19L can be selected. On the other hand, when the sheet size is a large size, only the manual-feeding orientations where the insertion orientation is short-edge feed (SEF) as in FIG. 18F, FIG. 18H, FIG. 18I, FIG. 18K, FIG. 19E, FIG. 19G, FIG. 19J, and FIG. 19L can be selected.

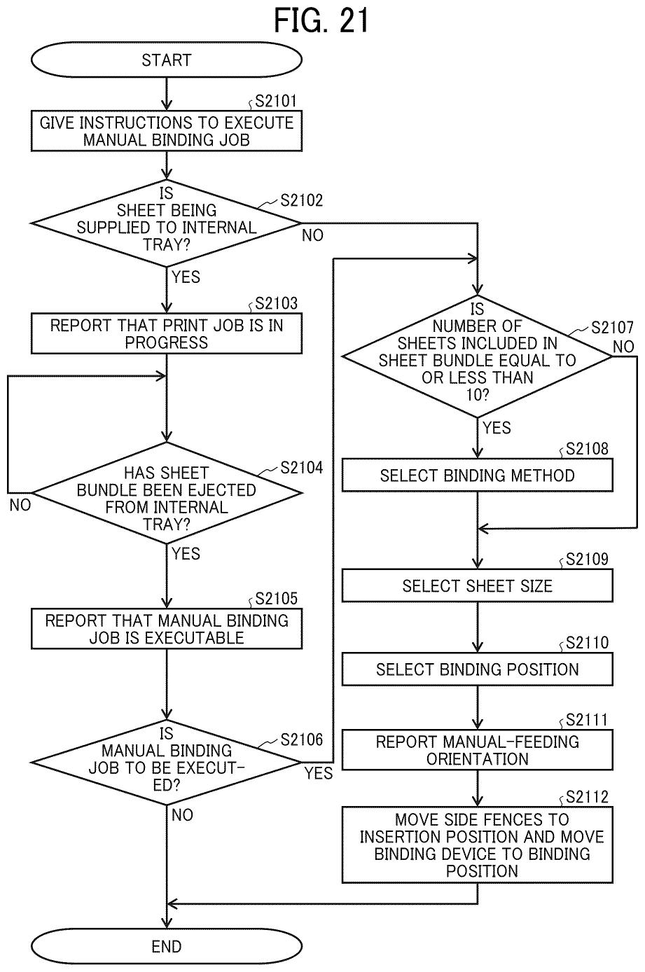

FIG. 21 is a flowchart of preparation processes for manual binding.

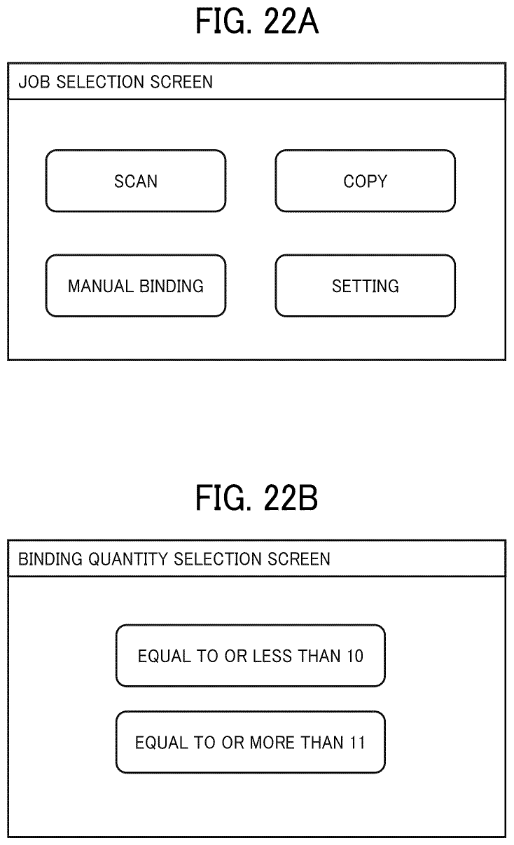

FIG. 22A is a diagram illustrating a job selection screen.

FIG. 22B is a diagram illustrating a binding quantity selection screen.

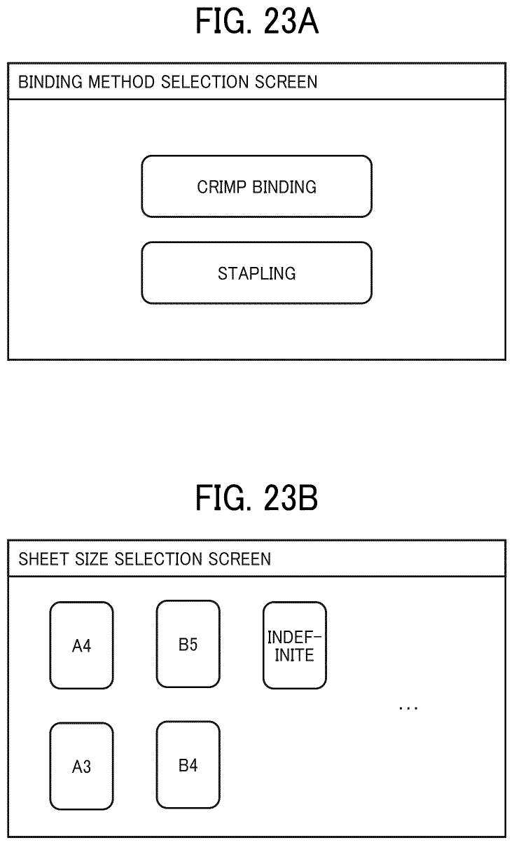

FIG. 23A is a diagram illustrating a binding method selection screen.

FIG. 23B is a diagram illustrating a sheet size selection screen.

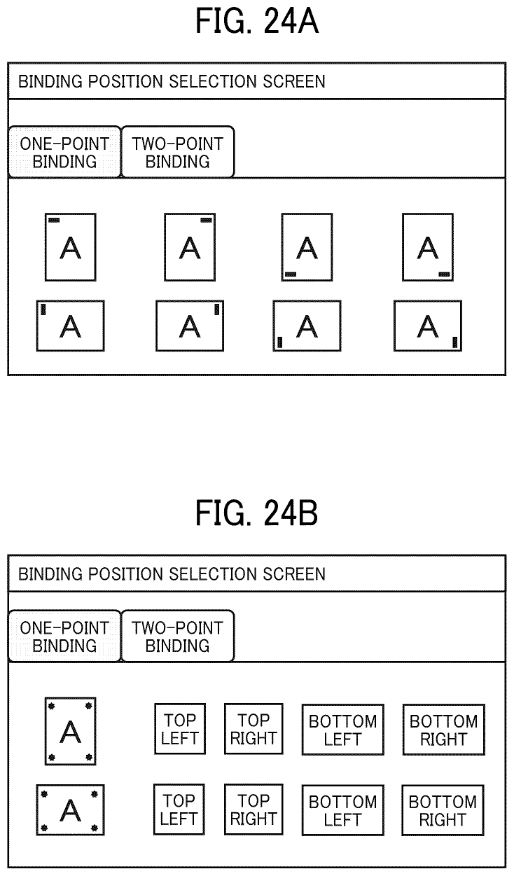

FIG. 24A and FIG. 24B are diagrams each of which illustrates a binding position selection screen.

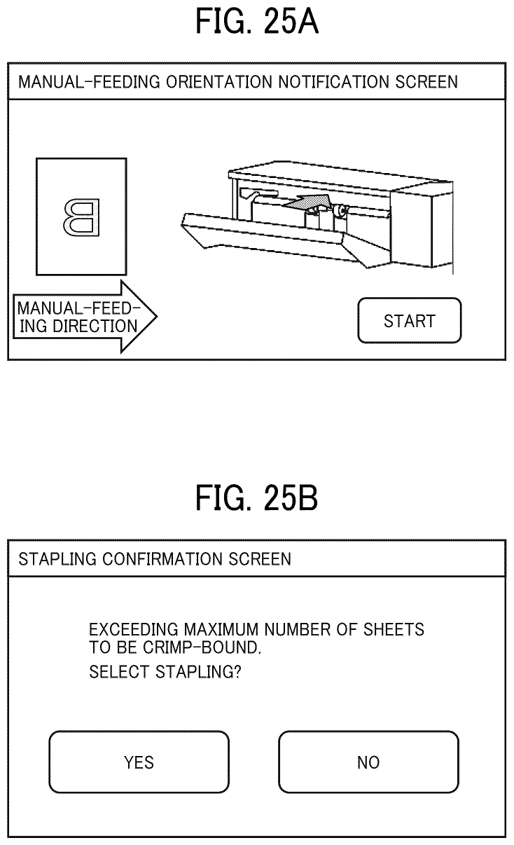

FIG. 25A is a diagram illustrating a manual-feeding orientation notification screen.

FIG. 25B is a diagram illustrating a stapling confirmation screen.

In the preparation processes for manual binding, the manual-feeding orientation of the sheet bundle Sb is determined based on the setting data of manual binding input by a user (e.g., the number of sheets to be bound, a binding method, a sheet size, and a binding position) and notification of the determined manual-feeding orientation is given.

Firstly, as illustrated in FIG. 22A, the controller 150 controls the display to display the job selection screen on the operation panel 149. The job selection screen prompts a user to select a job to be executed by the image forming system through the operation panel 149. For example, the job selection screen includes a “SCAN” icon, a “COPY” icon, a “MANUAL BINDING” icon, and a “SETTING” icon thereon.

The “SCAN” icon gives instructions to execute a reading job. In the reading job, the document reading device 102 is instructed to read the image formed on a document. The “COPY” icon gives instructions to form the image read in the reading job on the sheet S. A job in which the image forming device 115 forms an image on the sheet S is referred to as a print job in the following description. More specifically, when the “COPY” icon is touched or pressed down, a reading job and a print job are executed in order. Alternatively, the image that is indicated by the image data received from an external device is formed on the sheet S in a print job, and such a job may be referred to as “COPY.”

When a print job is to be executed, the controller 150 obtains the size of the sheets S, and the source such as an external device and the document reading device 102 where the image data of an image to be formed on the sheet S is originally generated, and the destination such as the first output tray 135 and the second output tray 32 to which the sheet S with the formed images is to be ejected. A print job in which the destination is the second output tray 32 may include instructions to perform binding, which is, for example, instructions for the binding apparatus 30 to bind the sheet bundle Sb with the formed images. In other words, the controller 150 instructs the image forming device 115 to eject or supply the sheet S with the formed images to the specified destination.

The “MANUAL BINDING” icon gives instructions to execute a manual binding job. In the manual binding job, the crimp binding device 42 or the stapler 43 is instructed to bind the sheet bundle Sb manually feed through the opening 31A. The “SETTING” icon prompts a user to change the various kinds of settings of the image forming system through the operation panel 149.

When the “MANUAL BINDING” icon is touched or pressed down in step S2101, in step S2102, the controller 150 determines whether a print job including instructions to perform binding is in progress. In other words, whether the sheet S on which an image has been formed by the image forming device 115 has been fed to the internal tray 37 is determined. When it is determined that a print job including instructions to perform binding is not in progress (YES in step S2102), in step S2103, the controller 150 notifies a user through the operation panel 149 that the print job is in progress and the sheet bundle Sb is not to be inserted through the opening 31A.

Subsequently, in step S2104, the controller 150 determines whether the print job including instructions to perform binding is completed and the sheet bundle Sb has been ejected from the internal tray 37. For example, when the sheet sensor 61 stops outputting a detection signal, it can be determined that the sheet bundle Sb has been ejected from the internal tray 37. When it is determined that the print job including instructions to perform binding is completed and the sheet bundle Sb has been ejected from the internal tray 37 (YES in step S2104), in step S2105, the controller 150 notifies a user through the operation panel 149 that manual binding job is executable.

Subsequently, when the execution of a manual binding job is specified by a user through the operation panel 149 (YES in step S2106), the controller 150 executes the processes in step S2107 and the following steps. When it is determined that a print job including instructions to perform binding is not in progress (NO in step S2102), the controller 150 skips the processes in steps S2103 to S2106 and executes the processes in step S2107 and the following steps. On the other hand, when the execution of a manual binding job is not specified by a user through the operation panel 149 (NO in step S2106), the controller 150 skips the processes in step S2107 and the following steps and ends the preparation processes for manual binding.

Subsequently, as illustrated in FIG. 22B, the controller 150 controls the display to display the binding quantity selection screen on the operation panel 149. The binding quantity selection screen prompts a user to input the number of the sheets S included in the sheet bundle Sb to be bound in the manual binding job. For example, the binding quantity selection screen includes “10 OR LESS” icon and “11 OR MORE” icon. In step S2107, the controller 150 prompts a user to input the number of sheets to be bound through the operation panel 149. The number of sheets to be bound is not strictly limited to a particular number, and whether the number of sheets to be bound is equal to or smaller than the maximum number of sheets that can be crimp-bound, i.e., 10, may be determined.

Subsequently, when the “10 OR LESS” icon is touched or pressed down (YES in step S2107), as illustrated in FIG. 23A, the controller 150 controls the display to display the binding method selection screen on the operation panel 149. The binding method selection screen prompts a user to select one of crimp binding and stapling, i.e., how to bind the sheet bundle Sb in the manual binding job. For example, the binding method selection screen includes a “CRIMP BINDING” icon and “STAPLE” icon. In step S2108, the controller 150 prompts a user to select or input the binding method through the operation panel 149. On the other hand, when the “11 OR MORE” icon is touched or pressed down (NO in step S2107), the controller 150 skips the processes in step S2108, and determines that “STAPLE” be used as the binding method.

Subsequently, as illustrated in FIG. 23B, the controller 150 controls the display to display the sheet size selection screen on the operation panel 149. The sheet size selection screen prompts a user to input the sheet size of the sheet bundle Sb to be bound in the manual binding job. For example, the sheet size selection screen includes “A4” icon, “A3” icon, “B5” icon, “B4” icon, and “INDEFINITE” icon. In step S2109, the controller 150 prompts a user to select or input the sheet size through the operation panel 149.

Subsequently, as illustrated in FIG. 24A and FIG. 24B, the controller 150 controls the display to display the binding position selection screen on the operation panel 149. The binding position selection screen prompts a user to input the binding position of the sheet bundle Sb to be bound in the manual binding job. In step S2110, the controller 150 prompts a user to select or input the binding position through the operation panel 149.

As illustrated in FIG. 24A and FIG. 24B, the binding position selection screen includes for example, a “one-point binding” tab, a “two-point binding” tab, and a plurality of icons indicating several binding positions. As illustrated in FIG. 24A, the binding position selection screen includes a plurality of candidate images indicating candidates for the binding position on the sheet bundle Sb. Such candidate images are icons indicating a combination of the binding position, the orientation of image “A” formed on the sheet bundle Sb, and the orientation of the sheet bundle Sb, which is vertical or horizontal. Alternatively, as illustrated in FIG. 24B, the binding position selection screen may include a plurality of icons in which the binding positions are indicated by texts. FIG. 24A and FIG. 24B illustrate cases in which the “one-point binding” tab is selected. However, no limitation is indicated thereby. When the “two-point binding” tab is selected, the binding position selection screen prompts a user to select one of the two-point binding positions.

Subsequently, in steps S2107 to S2110, the controller 150 determines the manual-feeding orientation (i.e., an insertion orientation, an image orientation, and a front-rear orientation) based on the binding method, the sheet size, and the binding position input by a user. More specifically, the controller 150 determines the manual-feeding orientation that correspond to the binding method, the sheet size, and the binding position input by a user, based on the relation depicted in FIG. 17 and FIG. 20. The order in which the processes in steps S2107 to S2110 are executed is not limited to the examples depicted in FIG. 21.

Subsequently, as illustrated in FIG. 25A, in step S2111, the controller 150 controls the display to display the manual-feeding orientation notification screen on the operation panel 149. The manual-feeding orientation notification screen notifies a user of the manual-feeding orientation determined by the controller 150. In other words, the controller 150 notifies a user of an insertion orientation, an image orientation, and a front-rear orientation through the manual-feeding orientation notification screen. In FIG. 25A, indication that the insertion orientation should be long-edge feed (LEF), the image orientation should be 0°, and the front-rear orientation should be downward and the orientation is given by way of illustration. However, no limitation is indicated thereby, and indication may be given by way of texts or voice.

The controller 150 notifies the controller 160 of the binding method, the sheet size, the binding position, and the manual-feeding orientation. In step S2112, the controller 160 moves the pair of side fences 41L and 41R to a pair of insertion positions based on the information notified from the controller 150, and moves the binding device associated with the binding method so as to face the binding position. The controller 160 makes the drive roller 36a and the driven roller 36b of the conveyance roller pair 36 separated from each other. Alternatively, the processes in step S2111 and step S2112 may be executed in parallel.

At the pair of insertion positions, the sheet bundle Sb that is manually feed through the opening 31A is insertable between the pair of side fences 41L and 41R. In other words, the controller 160 moves the pair of side fences 41L and 41R to the pair of insertion positions where the space between the side fences 41L and 41R is slightly larger than the width of the sheet bundle Sb in the main scanning direction, based on a combination of the sheet size and the insertion orientation.

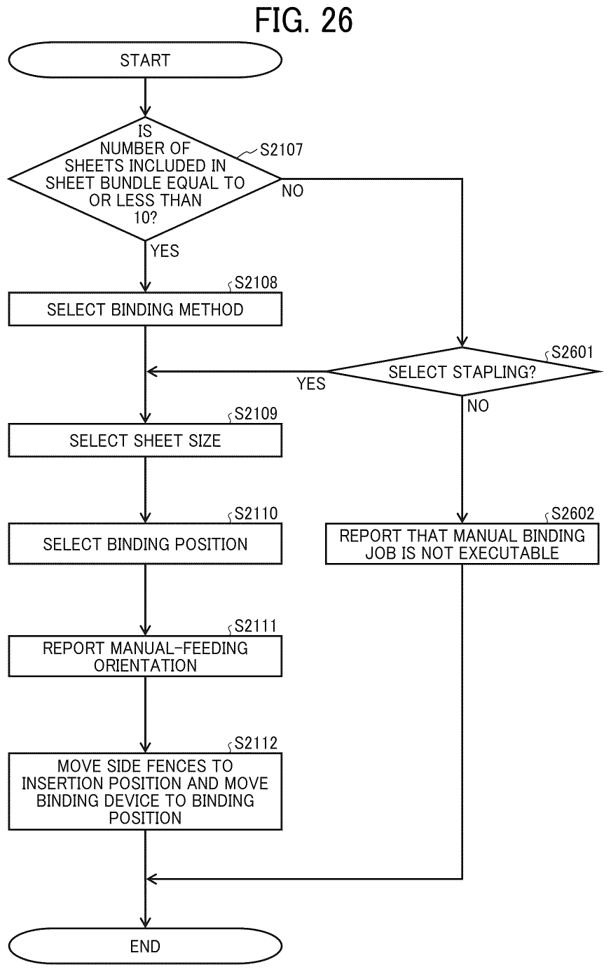

FIG. 26 is another flowchart of preparation processes for manual binding.

The processes in steps S2107 to S2112 are common to those in FIG. 21, and thus like reference signs are given thereto. In other words, FIG. 26 is different from FIG. 21 in the respect that the processes in step S2601 and step S2602 are added.

When the “11 OR MORE” icon is touched or pressed down (NO in step S2107), as illustrated in FIG. 25B, the controller 150 controls the display to display the stapling confirmation screen on the operation panel 149. The stapling confirmation screen prompts a user to select whether to execute a manual binding job with the binding method “stapling”. For example, the stapling confirmation screen includes a “YES” icon indicating that a manual binding job is to be executed with stapling and a “NO” icon indicating that a manual binding job is not to be executed with stapling.

When the “YES” icon is touched or pressed down (YES in step S2601), the controller 150 executes the processes in step S2109 and the following steps. On the other hand, when the “NO” icon is touched or pressed down (NO in step S2601), in step S2602, the controller 150 notifies a user that a manual binding job is not executable through the operation panel 149. Then, the controller 150 skips the processes in steps S2109 to S2112, and ends the preparation processes for manual binding.

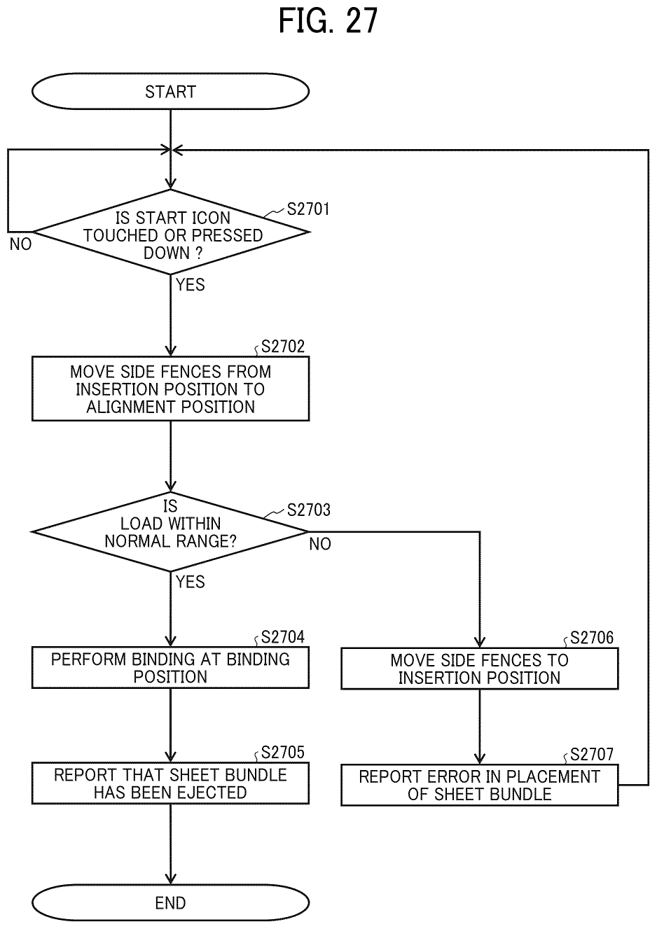

FIG. 27 is a flowchart of the processes of manual binding.

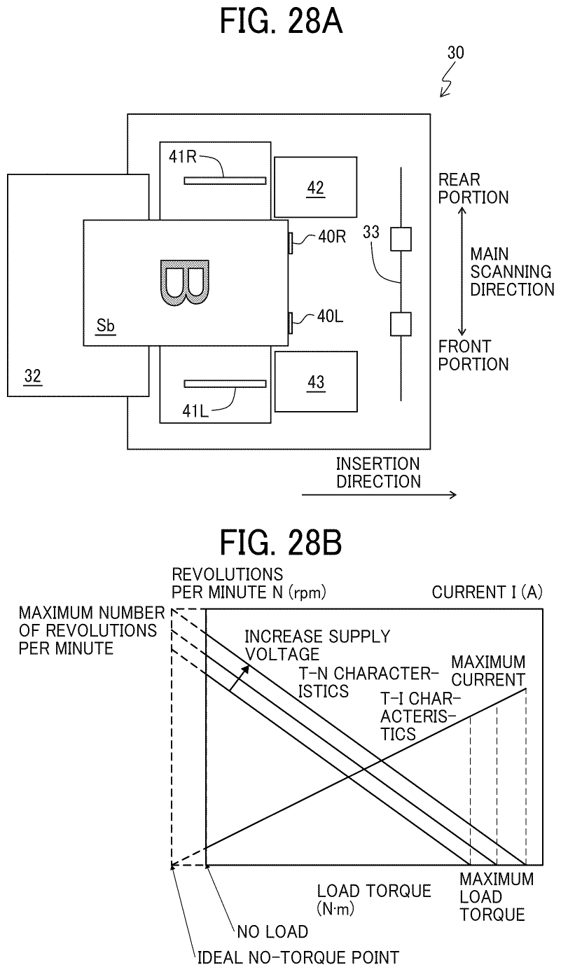

FIG. 28A is a diagram illustrating the sheet bundle Sb that is erroneously placed.

FIG. 28B is a diagram illustrating the relation between the torque and the number of revolutions per minute (rpm) of the fence motor 59L or the fence motor 59R.

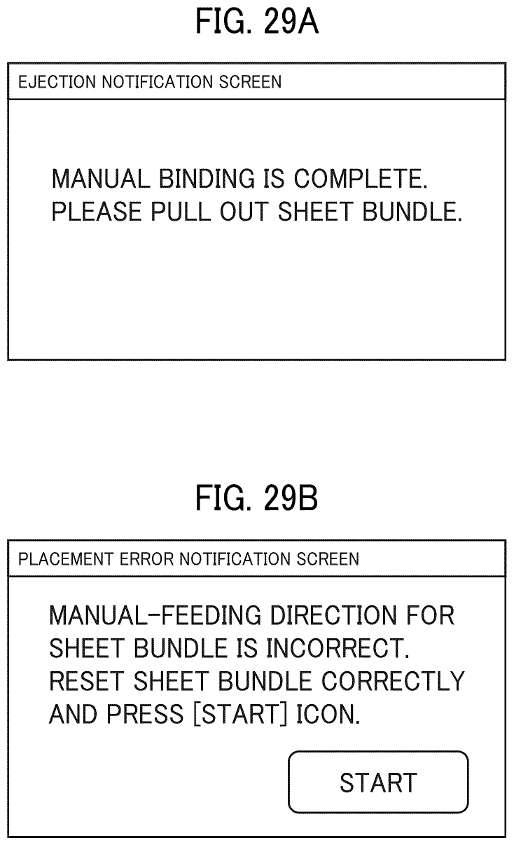

FIG. 29A is a diagram illustrating an ejection notification screen.

FIG. 29B is a diagram illustrating a placement error notification screen.

In the manual binding, the crimp binding device 42 or the stapler 43 is instructed to bind the sheet bundle Sb that is manually fed by a user through the opening 31A. The preparation processes for manual binding are executed prior to the execution of the manual binding, and the manual-feeding orientation notification screen is displayed.

When the “start” icon is not touched or pressed down on the manual-feeding orientation notification screen (NO in step S2701), the controller 150 waits and does not execute the processes in step S2702 and the following steps. A user manually feeds the sheet bundle Sb with the manual-feeding orientation indicated on the manual-feeding orientation notification screen, and touches or presses down the “START” icon. When the “START” icon is touched or pressed down (YES in step S2701), the controller 150 instructs the controller 160 to execute a manual binding job.

When the execution of the manual binding job is instructed from the controller 150, in step S2702, the controller 160 moves the pair of side fences 41L and 41R from the pair of insertion positions to a pair of alignment positions. At the pair of alignment positions, the side fences 41L and 41R contact both ends of the sheet bundle Sb in the main scanning direction to align the position of the multiple sheets S, which make up the sheet bundle Sb, in the main scanning direction. In other words, the controller 160 moves the pair of side fences 41L and 41R to the pair of alignment positions to contact both ends of the sheet bundle Sb in the main scanning direction, based on a combination of the sheet size and the insertion orientation.

For example, as illustrated in FIG. 28A, there may be some cases in which the sheet bundle Sb is manually fed with short-edge feed (SEF) by mistake when the sheet bundle Sb is to be manually fed by a user with long-edge feed (LEF) (such an erroneous operation for sheets may be referred to as an error in placement in the following description). In such cases, a binding device erroneously operates at a position where the sheet bundle Sb is not present when the binding device performs binding at the binding position as instructed by the controller 150. An error in placement is not limited to the above-described examples. As another example, there may be some cases in which the sheet bundle Sb is forcibly pushed in with long-edge feed (LEF) by mistake when the sheet bundle Sb is to be manually fed by a user with short-edge feed (SEF). As yet another example, there may be some cases in which an erroneous sheet size is input in step S2109.

The controller 160 performs feedback control on the fence motors 59L and 59R, which are an example of a driver. By so doing, the side fences 41L and 41R are moved to desired positions, which are an example of the pair of alignment positions. More specifically, when the load is heavy and the actual revolutions per minute (rpm) of the fence motors 59L and 59R are smaller than on-target revolutions per minute (rpm), the controller 160 increases the value of the current to be supplied to the fence motors 59L and 59R. When the load is light and the actual revolutions per minute (rpm) of the fence motors 59L and 59R are larger than on-target revolutions per minute (rpm), the controller 160 decreases the value of the current to be supplied to the fence motors 59L and 59R.

Due to such a configuration, as illustrated in FIG. 28A, when the width of the sheet bundle Sb, which is actually manually fed, in the main scanning direction is smaller than assumed width, the load is light and the value of the current to be supplied to the fence motors 59L and 59R becomes smaller than the lower limit of a predetermined permissible range. By contrast, when the width of the sheet bundle Sb, which is actually manually fed, in the main scanning direction is larger than assumed width, the load is heavy and the value of the current to be supplied to the fence motors 59L and 59R becomes larger than the upper limit of a predetermined permissible range. In order to deal with such a situation, when the value of the current to be supplied to the fence motors 59L and 59R goes out of the permissible range in the process of moving the pair of side fences 41L and 41R to a pair of alignment positions, the controller 160 determines that the loads on the fence motors 59L and 59R are in an abnormal rage.

When it is determined that the loads on the fence motors 59L and 59R are within a normal range (YES in step S2703), in step S2704, the controller 160 instructs the binding device to perform binding at a binding position after the side fences 41L and 41R have reached the alignment position. After the binding device has performed binding at a binding position, the controller 160 controls the operation panel 149 to display the ejection notification screen as illustrated in FIG. 29A. The ejection notification screen notifies a user that the manually-fed sheet bundle Sb is to be ejected.

By contrast, when it is determined that the loads on the fence motors 59L and 59R are in an abnormal range (NO in step S2703), in step S2706, the controller 160moves the pair of side fences 41L and 41R to the pair of insertion positions, and in step S2707, the controller 160 controls the display of the operation panel 149 to display the placement error notification screen as illustrated in FIG. 29B. The placement error notification screen notifies a user that the insertion orientation of the sheet bundle Sb through the opening 31A is wrong. A user who has seen the placement error notification screen takes out the sheet bundle Sb manually feed, and manually feeds the sheet bundle Sb again with an appropriate manual-feeding orientation. Then, a user touches or presses down the “START” icon on the placement error notification screen. When the “START” icon on the placement error notification screen is touched or pressed down (YES in step S2701), the controller 160 repeats the processes in step S2702 and the following steps.

According to the above embodiments of the present disclosure, a manual-feeding orientation suitable for a combination of the binding method, the sheet size, and the binding position is indicated. Due to such a configuration, the sheet bundle Sb can be inserted with an appropriate orientation and the sheet bundle Sb is crimp-bound at a desired binding position.

According to the above embodiments of the present disclosure, when the sheet bundle Sb is of a large size, the insertion orientation is fixed to short-edge feed (SEF), and the image orientation and the front-rear orientation are adjusted in order to bind the sheet bundle Sb at a desired binding position. Due to such a configuration, the sheet bundle Sb can be crimp-bound at a desired position regardless of its varying sizes.

According to the above embodiments of the present disclosure, the pair of side fences 41L and 41R are moved to a pair of insertion positions in advance before the sheet bundle Sb is manually fed. Due to such a configuration, the manual feeding of the sheet bundle Sb with an appropriate orientation can be supported. Compared with cases in which the side fences 41L and 41R are instructed to wait at standby positions, the length of time required to execute a manual binding job can be shortened.

According to the above embodiments of the present disclosure, an error in placement is detected for the sheet bundle Sb and notification of such an error is provided. Due to such a configuration, binding a position different from a desired position is prevented or, a binding device is prevented from erroneously operating at a position where the sheet bundle Sb is not present. As an error in placement is detected based on the load on the side fences 41L and 41R or the values of the current, the configuration or structure of the binding apparatus 30 can be simplified compared with cases in which a sensor to detect the actual orientation of the sheet bundle Sb that is manually feed is to be newly added.

According to the above embodiments of the present disclosure, as illustrated in FIG. 24A, a user is prompted to select a binding position from candidate images indicating a combination of the orientation of the sheet bundle Sb, which is vertical or horizontal, the orientation of image “A” formed on the sheet bundle Sb, and the binding position. Due to such a configuration, a user can recognize a desired binding position easily and intuitively.

Moreover, according to the above embodiments of the present disclosure, the sheet S to be ejected in a print job and the sheet bundle Sb that is manually fed do not interfere with each other and a paper jam can be prevented from occurring by executing the processes in steps S2102 to S2106. When the sheet S to be ejected in a print job and the sheet bundle Sb that is manually fed do not interfere with each other, a print job and a manual binding job may be executed in parallel in order to increase the productivity of the image forming system.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

The above-described processes may be implemented by, for example, a program. In other words, the above-described processes may be implemented as the CPU 151 or the CPU 161, which is an example of a processor, executes a program stored in the memory 152 or the memory 162. The program is not limited to a single program, and may be a collection or combination of a plurality of programs. The program is not necessarily executed by one of the CPU 151 and the CPU 161, but may be executed by both the CPU 151 and the CPU 161 in a divided manner. The program may be written in, for example, a storage device or a storage medium and distributed with the storage device or the storage medium, or may be distributed through, for example, a telecommunication line.

Aspects of the present disclosure are, for example, as follows.

### First Aspect

A medium processing apparatus that processes a medium bundle including a plurality of medium includes a housing having an opening through which the medium bundle is insertable in an insertion direction, a crimp binding device to crimp the medium bundle inserted through the opening on one side in a main scanning direction orthogonal to the insertion direction, an input device to receive an input on a medium size of the medium and a binding position of the medium bundle to be crimp-bound by the crimp binding device, a controller configured to determine an insertion orientation of the medium bundle to be inserted into the opening, an image orientation of an image on at least one of the plurality of media, and a front-rear orientation of the medium bundle, based on the medium size and the binding position received by the input device, and a notifying device to provide notification of the insertion orientation, the image orientation, and the front-rear orientation determined by the controller.

### Second Aspect

In the medium processing apparatus according to the first aspect, a pair of adjusters are further provided to contact both ends of the medium bundle in the main scanning direction to align the plurality of media of the medium bundle in the main scanning direction. When a length of long sides of the plurality of media indicated by the medium size is greater than a maximum space of the adjuster, the controller determines the insertion orientation to make the long sides be parallel to the insertion direction.

### Third Aspect

In the medium processing apparatus according to the second aspect, a driver to generate a driving force for moving the pair of adjusters in the main scanning direction is further provided, and the controller moves the pair of adjusters to a pair of insertion positions where the medium bundle is insertable between the pair of adjusters, based on a length of the medium bundle in the main scanning direction specified by the medium size and the insertion orientation.

### Fourth Aspect

In the medium processing apparatus according to the third aspect, after the medium bundle is inserted through the opening, the controller moves the adjuster to a pair of alignment positions to align the plurality of media, and when detected that a load on the driver is in an abnormal range in a process of moving the pair of adjusters to the pair of alignment positions, the controller provides notification that the insertion orientation of the medium bundle through the opening is wrong through the notifying device.

### Fifth Aspect

In the medium processing apparatus according to any one of the first to fourth aspects, the controller provides notification through the notifying device of a plurality of candidate images indicating a plurality of candidates for the binding position on the medium bundle and one of the plurality of candidate images is to be selected as the binding position.

### Sixth Aspect

An image forming system includes an image forming apparatus to form an image on at least one of a plurality of media, a medium processing apparatus including a crimp binding device to perform crimp binding on a medium bundle including the plurality of media conveyed from the image forming apparatus in a conveyance direction and another medium bundle manually fed in an insertion direction, on one side in a main scanning direction orthogonal to the insertion direction and the conveyance direction, an input device to receive an input on a medium size of the plurality of media and a binding position of the medium bundle or the another medium bundle to be crimp-bound by the crimp binding device, a controller to determine an insertion orientation of the another medium bundle manually fed, an image orientation of an image on the another medium bundle manually fed, and a front-rear orientation of the another medium bundle manually fed, based on the medium size and the binding position received by the input device, and a notifying device to provide notification of the insertion orientation, the image orientation, and the front-rear orientation determined by the controller.

### Seventh Aspect

An image forming system includes an image forming apparatus to form an image on at least one of a plurality of media, a medium processing apparatus including a crimp binding device to perform crimp binding on a medium bundle including the plurality of media conveyed from the image forming apparatus in a conveyance direction and another medium bundle manually fed in an insertion direction and placed on a container, on one side in a main scanning direction orthogonal to the insertion direction and the conveyance direction, an input device to receive an input on a medium size of the plurality of media manually fed and a binding position of the medium bundle that is manually fed and is to be crimp-bound by the crimp binding device, a controller configured to determine an insertion orientation of the another medium bundle manually fed, an image orientation of an image on the another medium bundle manually fed, and a front-rear orientation of the another medium bundle manually fed, based on the medium size and the binding position received by the input device, and a notifying device to provide notification of the insertion orientation, the image orientation, and the front-rear orientation determined by the controller. When the plurality of media on which the image has been formed by the image forming apparatus is placed in the container, the controller provides notification through the notifying device that the another medium bundle manually fed is not to be inserted. When the plurality of media on which the image has been formed by the image forming apparatus is fed to a place other than the container, the controller continues an operation of the image forming apparatus and provides notification of the insertion orientation, the image orientation, and the front-rear orientation through the notifying device.

### Eighth Aspect

A non-transitory recording medium that stores a plurality of instructions which, when executed by one or more processors, causes the one or more processors to perform a method, is provided, and the one or more processors are provided for a medium processing apparatus including a crimp binding device to perform crimp binding on a medium bundle including a plurality of media conveyed from an image forming apparatus in a conveyance direction and another medium bundle manually fed in an insertion direction and placed on a container, on one side in a main scanning direction orthogonal to the insertion direction and the conveyance direction, an input device to receive an input on a medium size of the plurality of media manually fed and a binding position of the medium bundle that is manually fed and is to be crimp-bound by the crimp binding device and a notifying device to provide notification of an insertion orientation of the another medium bundle manually fed, an image orientation of an image on the another medium bundle manually fed, and a front-rear orientation of the another medium bundle manually fed. The method includes a step to determine the insertion orientation, the image orientation, and the front-rear orientation based on the medium size and the binding position received by the input device.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or digital versatile disk (DVD), and/or the memory of an FPGA or ASIC.

What is claimed is:

1. A medium processing apparatus comprising:
a housing having an opening through which a medium bundle including a plurality of media is inserted in an insertion direction;
a crimp binding device to crimp the medium bundle inserted through the opening on one side in a main scanning direction orthogonal to the insertion direction;
an input device to receive an input on a medium size of the plurality of media and a binding position of the medium bundle to be crimp-bound by the crimp binding device;
processing circuitry configured to determine an insertion orientation of the medium bundle to be inserted into the opening, an image orientation of an image on at least one of the plurality of media, and a front-rear orientation of the medium bundle, based on the medium size and the binding position received by the input device; and
a notifying device to provide notification of the insertion orientation, the image orientation, and the front-rear orientation determined by the processing circuitry.

2. The medium processing apparatus according to claim 1, further comprising
a pair of adjusters to contact both ends of the medium bundle in the main scanning direction to align the plurality of media of the medium bundle in the main scanning direction,
wherein when a length of long sides of the plurality of media indicated by the medium size is greater than a maximum space of the pair of adjusters, the processing circuitry determines the insertion orientation to make the long sides be parallel to the insertion direction.

3. The medium processing apparatus according to claim 2, further comprising
a driver to generate a driving force for moving the pair of adjusters in the main scanning direction,
wherein the processing circuitry moves the pair of adjusters to a pair of insertion positions where the medium bundle is insertable between the pair of adjusters, based on a length of the medium bundle in the main scanning direction specified by the medium size and the insertion orientation.

4. The medium processing apparatus according to claim 3,
wherein after the medium bundle is inserted through the opening, the processing circuitry moves the pair of adjusters to a pair of alignment positions to align the plurality of media, and
wherein when detected that a load on the driver is in an abnormal range in a process of moving the pair of adjusters to the pair of alignment positions, the processing circuitry provides notification that the insertion orientation of the medium bundle through the opening is wrong through the notifying device.

5. The medium processing apparatus according to claim 1,
wherein the processing circuitry provides notification through the notifying device of a plurality of candidate images indicating a plurality of candidates for the binding position on the medium bundle and one of the plurality of candidate images is to be selected as the binding position.

6. An image forming system comprising:
an image forming apparatus to form an image on at least one of a plurality of media;
a medium processing apparatus including a crimp binding device to perform crimp binding on a medium bundle including the plurality of media conveyed from the image forming apparatus in a conveyance direction and another medium bundle manually fed in an insertion direction, on one side in a main scanning direction orthogonal to the insertion direction and the conveyance direction;
an input device to receive an input on a medium size of the plurality of media and a binding position of the medium bundle or the another medium bundle to be crimp-bound by the crimp binding device;
processing circuitry configured to determine an insertion orientation of the another medium bundle manually fed, an image orientation of an image on the another medium bundle manually fed, and a front-rear orientation of the another medium bundle manually fed, based on the medium size and the binding position received by the input device; and
a notifying device to provide notification of the insertion orientation, the image orientation, and the front-rear orientation determined by the processing circuitry.

7. An image forming system comprising:
an image forming apparatus to form an image on at least one of a plurality of media;
a medium processing apparatus including a crimp binding device to perform crimp binding on a medium bundle including the plurality of media conveyed from the image forming apparatus in a conveyance direction and another medium bundle manually fed in an insertion direction and placed on a container, on one side in a main scanning direction orthogonal to the insertion direction and the conveyance direction;
an input device to receive an input on a medium size of the another medium bundle manually fed and a binding position of the another medium bundle that is manually fed and is to be crimp-bound by the crimp binding device;
processing circuitry configured to determine an insertion orientation of the another medium bundle manually fed, an image orientation of an image on the another medium bundle manually fed, and a front-rear orientation of the another medium bundle manually fed, based on the medium size and the binding position received by the input device; and
a notifying device to provide notification of the insertion orientation, the image orientation, and the front-rear orientation determined by the processing circuitry,
wherein when the plurality of media on which the image has been formed by the image forming apparatus is placed in the container, the processing circuitry provides notification through the notifying device that the another medium bundle manually fed is not to be inserted, and
wherein when the plurality of media on which the image has been formed by the image forming apparatus is fed to a place other than the container, the processing circuitry continues an operation of the image forming apparatus and provides notification of the insertion orientation, the image orientation, and the front-rear orientation through the notifying device.
